(19) United States
(12) Patent Application Publication
(10) Pub. No.: US 2021/0382263 A1
(43) Pub. Date: Dec. 9, 2021

(54) LENS DRIVING DEVICE, AND CAMERA MODULE AND OPTICAL DEVICE INCLUDING SAME

(71) Applicant: LG INNOTEK CO., LTD., Seoul (KR)

(72) Inventors: Jun Taek LEE, Seoul (KR); Byung Wook SON, Seoul (KR)

(21) Appl. No.: 17/056,987

(22) PCT Filed: May 30, 2019
(86) PCT No.: PCT/KR2019/006472

§ 371 Date: Nov. 19, 2020

(30) Foreign Application Priority Data
May 30, 2018 (KR) 10-2018-0061739

(51) Int. Cl. G02B 7/09; G03B 17/12; G02B 7/02; G03B 5/04; H04N 5/225; H02K 41/035

(52) U.S. Cl. CPC G02B 7/09; G03B 17/12; G02B 7/023; G03B 2205/0069; H04N 5/2253; H02K 41/0354; G02B 7/025; G03B 5/04

(57) ABSTRACT

One embodiment comprises a housing, a bobbin arranged in the housing, a coil arranged in the bobbin, a magnet arranged in the housing, and an elastic member coupled to the bobbin, wherein the elastic member comprises a body and an extension portion extending from the body, the bobbin comprises a first surface and a second surface for forming a step with the first surface, the body is arranged on the first surface of the bobbin, and the extension portion is coupled to the coil and includes a first area bent toward the second surface of the bobbin from the body.

### CROSS-REFERENCE TO RELATED APPLICATIONS

This application is the U.S. national stage application of International Patent Application No. PCT/KR2019/006472, filed May 30, 2019, which claims the benefit under 35 U.S.C. § 119 of Korean Application No. 10-2018-0061739, filed May 30, 2018, the disclosures of each of which are incorporated herein by reference in their entirety.

### TECHNICAL FIELD

Embodiments relate to a lens moving apparatus and a camera module and an optical device including the same.

### BACKGROUND ART

It is difficult to apply technology of a voice coil motor (VCM) used in existing general camera modules to a subminiature, low-power camera module, and therefore research related thereto has been actively conducted.

In the case of a camera module configured to be mounted in a small electronic product, such as a smart phone, the camera module may frequently receive shocks during use, and may undergo fine shaking due to, for example, the shaking of a user's hand. In consideration thereof, technology enabling a device for inhibiting handshaking to be additionally installed to a camera module is being developed.

### DISCLOSURE

### Technical Problem

Embodiments provide a lens moving apparatus, which is capable of reducing the size thereof in the optical-axis direction and improving solderability between a coil and an elastic unit, and a camera module and an optical device each including the same.

### Technical Solution

A lens moving apparatus according to an embodiment includes a housing, a bobbin disposed in the housing, a coil disposed at the bobbin, a magnet disposed at the housing, and an elastic member coupled to the bobbin, wherein the elastic member includes a body and an extension, which extends from the body, wherein the bobbin includes a first surface and a second surface having a height difference from the first surface, wherein the body is disposed on the first surface of the bobbin, and wherein the extension includes a first region, which is coupled to the coil and is bent toward the second surface of the bobbin from the body.

The elastic member may be disposed under the bobbin. The coil may be soldered to the extension so as to be conductively connected to the extension.

The bobbin may include a third surface and a fourth surface having a height difference from the third surface, wherein the elastic member may include a first elastic unit and a second elastic unit, wherein the first elastic unit may include a first body and a first extension, which extends from the first body and is bent toward the second surface, and wherein the second elastic unit may include a second body and a second extension, which extends from the second body and is bent toward the fourth surface.

The second surface of the bobbin and the fourth surface of the bobbin may be the same surface.

The second surface of the bobbin and the fourth surface of the bobbin may be disposed in the same plane, and the first surface of the bobbin and the third surface of the bobbin may be disposed in the same plane.

The extension may include a second region, which is bent from the first region and is disposed on the second surface.

The elastic member may be disposed under the bobbin, wherein a lower surface of the bobbin may include the first surface and the second surface, and wherein the second surface may be positioned higher than the first surface.

The first elastic unit may include a first inner portion coupled to the bobbin, a first outer portion coupled to the housing and a first connector connecting the first inner portion to the first outer portion, and the second elastic unit may include a second outer portion coupled to the bobbin, a second outer portion coupled to the housing and a second connector connecting the second inner portion to the second outer portion.

The first connector may overlap the second surface of the bobbin in an optical-axis direction, and the second connector may overlap the fourth surface of the bobbin in the optical-axis direction.

The bobbin may include first and second projections, which are spaced apart from each other, and third and fourth projections, which are spaced apart from each other, wherein a first end of the coil may be disposed between the first and second projections, and a second end of the coil may be disposed between the third and fourth projections.

The second surface of the bobbin may be disposed between the first projection and the second projection, and the second surface may be disposed between the third projection and the fourth projection.

The lens moving apparatus may further include a first solder, connecting the first end of the coil to the first extension, and a second solder connecting the second end of the coil to the second extension, and a height of each of the first and second solders may be less than a height difference between the first surface and the second surface.

A height of each of the first solder and second solder may be equal to or less than a length of the first region in the optical-axis direction.

The first and second solders may be coupled to one of the first and second regions of the first extension.

A lens moving apparatus according to another embodiment includes a bobbin, a coil disposed at the bobbin, a magnet disposed so as to face the coil, and an elastic member coupled to the bobbin, wherein the elastic member includes a first elastic unit and a second elastic unit, which is spaced apart from the first elastic unit, wherein the first elastic unit includes a first body and a first extension, which extends from the first body, wherein the bobbin includes a first surface and a second surface, which is formed at a level different from a level of the first surface, wherein a portion of the first body is disposed on the first surface of the bobbin, and wherein the first extension is disposed on the second surface of the bobbin and is coupled to the coil.

A lens moving apparatus according to a further embodiment includes a housing, a bobbin disposed in the housing, a coil disposed at the bobbin, a magnet disposed at the housing, and an elastic member coupled to the bobbin, wherein the elastic member includes a first elastic unit and a second elastic unit, wherein the bobbin includes a first surface, to which the first elastic unit and the second elastic unit are coupled, and a second surface having a height difference from the first surface in an optical-axis direction, wherein the first elastic unit includes a first inner portion coupled to the first surface of the bobbin and a first extension, which extends toward the second surface from the first surface of the bobbin, wherein the second elastic unit includes a second inner portion coupled to the first surface of the bobbin and a second extension, which is connected to the second inner portion and extends toward the second surface from the first surface of the bobbin, wherein a first end of the coil is coupled to the first extension, and wherein a second end of the coil is coupled to the second extension.

The first elastic unit may include a first outer portion coupled to the housing and a first connector connecting the first inner portion to the first outer portion, wherein the second elastic unit may include a second outer portion coupled to the housing and a second connector connecting the second inner portion to the second outer portion, wherein the second surface of the bobbin may include a first area, which overlaps the first and second connectors in the optical-axis direction, and a second area, which does not overlap the first and second connectors in the optical-axis direction, wherein the first end of the coil and the first extension may be coupled to each other in the second area, and wherein the second end of the coil and the second extension may be coupled to each other in the second area.

### Advantageous Effects

Embodiments are able to reduce the size thereof in the optical-axis direction and improve solderability between a coil and an elastic unit.

### DESCRIPTION OF DRAWINGS

FIG. 1 is a perspective view of a lens moving apparatus according to an embodiment;

FIG. 2 is an exploded perspective view of the lens moving apparatus shown in FIG. 1;

FIG. 3 is an assembled perspective view of the lens moving apparatus, from which a cover member is removed;

FIG. 4 is a perspective view of the bobbin shown in FIG. 2;

FIG. 5 is a view illustrating the bobbin, the coil, the sensing magnet, and the balancing magnet, which are shown in FIG. 2;

FIG. 6A is a perspective view of the housing shown in FIG. 2;

FIG. 6B is a perspective view of the housing to which a magnet, a circuit board and a position sensor are coupled;

FIG. 7 is a view illustrating an embodiment of the position sensor shown in FIG. 2;

FIG. 8 is a plan view illustrating an upper elastic member;

FIG. 9 is a perspective view of the lower elastic member;

FIG. 10 is a view illustrating the connection between the circuit board and the first and second lower elastic units;

FIG. 11 is a view illustrating the lower elastic member, the base and the circuit board;

FIG. 12 is a cross-sectional view of the lens moving apparatus taken along line A-B in FIG. 3;

FIG. 13 is a cross-sectional view of the lens moving apparatus taken along line C-D in FIG. 3;

FIG. 14 is a cross-sectional view of the lens moving apparatus shown in FIG. 3, taken along line E-F;

FIG. 15A is a view illustrating one end and the other end of the coil disposed on the lower surface of the bobbin;

FIG. 15B is an enlarged view of a portion of the lower surface of the bobbin;

FIG. 16 is a bottom view of the lens moving apparatus shown in FIG. 3, from which the base is removed;

FIG. 17A is a view illustrating a first dotted portion in FIG. 16;

FIG. 17B is a view illustrating a second dotted portion in FIG. 16;

FIG. 18 is an enlarged view of the first extension;

FIG. 19A is a view illustrating an embodiment of the first solder coupling the first extension to the one end of the coil 120;

FIG. 19B is a view illustrating another embodiment of the first solder coupling the first extension to the one end of the coil;

FIG. 19C is a view illustrating a further embodiment of the first solder coupling the first extension to the one end of the coil;

FIG. 20A is a view illustrating the first extension according to an embodiment;

FIG. 20B is a view illustrating a first extension according to another embodiment;

FIG. 20C is a view illustrating a first extension according to a further embodiment;

FIG. 20D is a view illustrating a first extension according to yet a further embodiment;

FIG. 21 is an exploded perspective view illustrating a camera module according to an embodiment;

FIG. 22 is a perspective view of a portable terminal according to an embodiment; and

FIG. 23 is a view illustrating the configuration of the portable terminal shown in FIG. 22.

### BEST MODE

Hereinafter, embodiments of the present invention capable of concretely achieving the above objects will be described with reference to the accompanying drawings.

In the following description of the embodiments, it will be understood that, when an element is referred to as being formed “on” or “under” another element, it can be directly “on” or “under” the other element, or can be indirectly disposed relative thereto, with one or more intervening elements therebetween. In addition, it will also be understood that “on” or “under” the element may mean an upward direction or a downward direction based on the element.

In addition, relative terms such as, for example, “first”, “second”, “on/upper/above” and “beneath/lower/below”, used in the following description, may be used to distinguish any one substance or element from another substance or element without requiring or implying any physical or logical relationship or sequence between these substances or elements. The same reference numeral designates the same element throughout all of the drawings.

Unless otherwise defined, the terms “comprise,” “include” or “have” used in the above description are used to designate the presence of features, steps or combinations thereof described in the specification, and should be understood as not excluding the presence or possibility of additional inclusion of one or more different features, steps or combinations thereof. Furthermore, the term “correspond” or the like may include at least one of the meanings of “face” and “overlap”.

For convenience of description, although the lens moving apparatus according to an embodiment is described using a Cartesian coordinate system (x, y, z), the lens moving apparatus may be described using some other coordinate systems, and the embodiments are not limited thereto. In the respective drawings, the X-axis direction and the Y-axis direction mean directions perpendicular to an optical axis, i.e. the Z-axis. The Z-axis direction, which is the optical-axis direction or is a direction parallel to the optical axis, may be referred to as a “first direction”, the X-axis direction may be referred to as a “second direction”, and the Y-axis direction may be referred to as a “third direction”.

The term “auto-focusing function” may be a function of moving a lens in an optical-axis direction according to a distance to an object and thus automatically focusing on the object so as to obtain a clear image in an image sensor. The lens moving apparatus according to an embodiment may move an optical module, which is constituted of at least one lens, in the first direction so as to perform auto-focusing. Hereinafter, the lens moving apparatus may alternatively be referred to as a “VCM (Voice Coil Motor)”, a “lens-driving motor”, or an “actuator”.

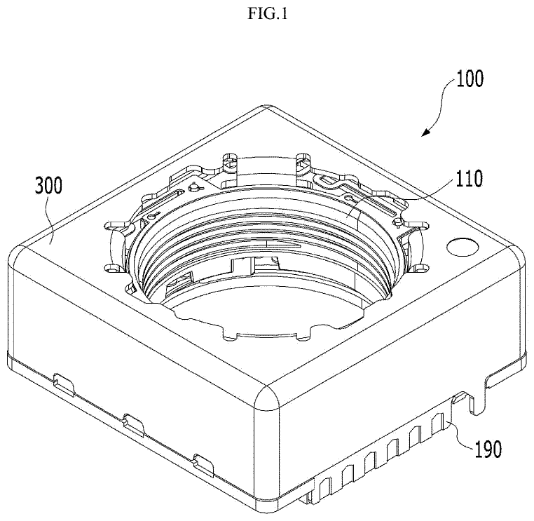

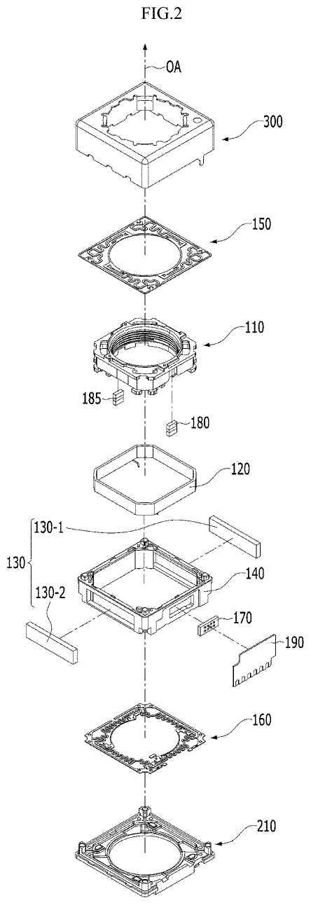

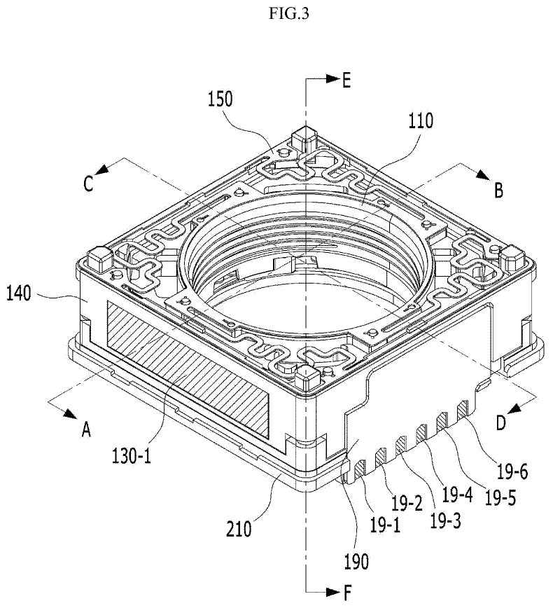

FIG. 1 is an exploded perspective of the lens moving apparatus 100 according to an embodiment. FIG. 2 is an exploded perspective view of the lens moving apparatus 100 shown in FIG. 1. FIG. 3 is an assembled perspective view of the lens moving apparatus 100, from which a cover member 300 is removed.

Referring to FIGS. 1 to 3, the lens moving apparatus 100 includes a bobbin 110, a coil 120, a magnet 130, a housing 140, an upper elastic member 150 and a lower elastic member 160.

The lens moving apparatus 100 may further include a position sensor 170 and a circuit board 190 for AF feedback operation. The lens moving apparatus 100 may include a sensing magnet 180 for enabling the position sensor 170 to detect magnetic force. Furthermore, the lens moving apparatus 100 may further include a balancing magnet 185 for alleviating influence of a magnetic field of the sensing magnet 180.

The lens moving apparatus 100 may further include a cover member 300 and a base 210.

First, the bobbin 110 will be described.

The bobbin 110 may be disposed in the housing 140 so as to be movable in the direction of the optical axis OA or the first direction (for example, the Z-axis direction) by the electromagnetic interaction between the coil 120 and the magnet 130.

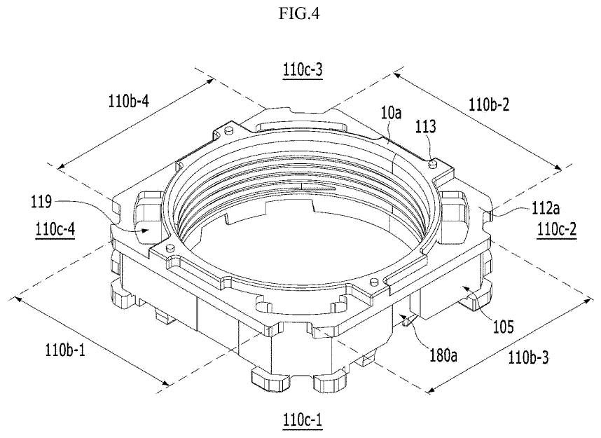

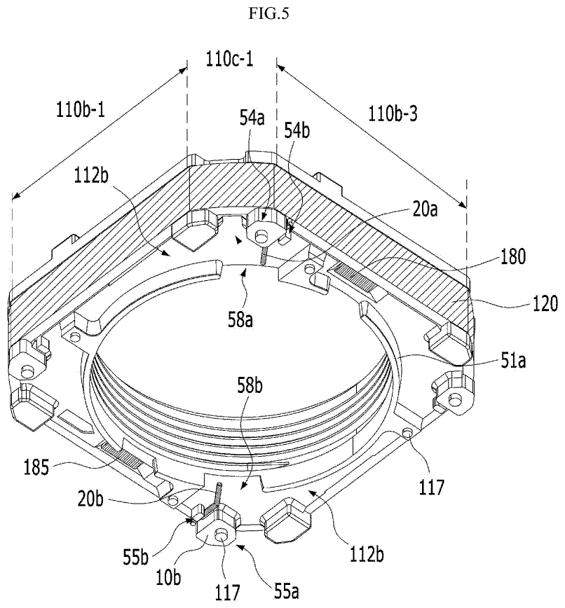

FIG. 4 is a perspective view of the bobbin 110 shown in FIG. 2. FIG. 5 is a view illustrating the bobbin 110, the coil 120, the sensing magnet 180, and the balancing magnet 185, which are shown in FIG. 2.

Referring to FIGS. 4 and 5, a lens or a lens barrel may be mounted in the bobbin 110, and the bobbin 110 may be disposed in the housing 140.

The bobbin 110 may have a bore configured to allow a lens or a lens barrel to be mounted therein.

For example, the bore in the bobbin 110 may be a through hole, and may have a circular shape, an elliptical shape, or a polygonal shape, without being limited thereto.

The bobbin 110 may include a first coupler 113, which is disposed on the upper surface thereof and is coupled or secured to the first inner frame 151 of the upper elastic member 150, and a second coupler 117, which is disposed on the lower surface thereof and is coupled or secured to the second inner frame 161 of the lower elastic member 160.

Although each of the first and second couplers 113 and 117 is illustrated in FIGS. 4 and 5 as being configured to have the form of a protrusion, the disclosure is not limited thereto. In another embodiment, each of the first and second couplers 113 and 117 may have the form of a groove or a flat surface.

The bobbin 110 may have a first escape groove 112a formed in a region of the upper surface 10a that corresponds to or is aligned with the first frame connector 153 of the upper elastic member 150. For example, the first escape groove 112a may have a shape depressed from the upper surface 10a of the bobbin 110. For example, the first height difference between the upper surface 10a of the bobbin 110 and the bottom surface of the first escape groove 112a may be 0.1 mm-0.15 mm. Here, the first height difference is set to be sufficient to inhibit spatial interference between the first frame connector 151 and the bobbin 110 caused by motion of the first frame connector 151 during movement of the bobbin 110.

Furthermore, the bobbin 110 may have a second escape groove 112b formed in a region of the lower surface 10b thereof that corresponds to or is aligned with the second frame connector 163 of the lower elastic member 160 in the optical-axis direction. The second escape groove 112b may have a shape depressed from the lower surface 10b of the bobbin 110.

By virtue of the first escape groove 112a and the second escape groove 112b in the bobbin 110, when the bobbin 110 is moved in the first direction, spatial interference between the first frame connector 153 and the second frame connector 163 and the bobbin 110 is eliminated, thereby allowing the first frame connector 153 and the second frame connector 163 to be elastically deformed with ease.

The bobbin 110 may include a plurality of lateral surfaces or outer surfaces.

The bobbin 110 may include side portions 110b-1 to 110b-4 and corner portions 110c-1 to 110c-4. Each of the first to fourth corner portions of the bobbin 110 may be disposed between two adjacent side portions of the bobbin 110.

The lateral surfaces or outer surfaces of the first to fourth side portions 110b-1 to 110b-4 of the bobbin 110 may be referred to as “first to fourth lateral surfaces” or “first to fourth outer surfaces”.

For example, the surface area of the lateral surface or outer surface of each of the first to fourth corner portions 110c-1 to 110c-4 may be smaller than the surface area of the lateral surface or the outer surface of each of the first to fourth side portions 110b-1 to 110b-4. For example, the horizontal length of the lateral surface or the outer surface of each of the first to fourth corner portions 110c-1 to 110c-4 may be less than the horizontal length of the lateral surface or the outer surface of each of the first to fourth side portions 110b-1 to 110b-4.

For seating of the coil 120, the bobbin 110 may have a groove 10-5 formed in the outer surface thereof. In another embodiment, for winding or holding the coil 120, the bobbin 110 may be provided on the outer surface thereof with at least one protrusion.

For mounting or disposing the sensing magnet 180, the bobbin 110 may have a first groove 180a formed in one of the side portions 110b-1 to 110b-4.

For mounting or disposing the balancing magnet 185, the bobbin 110 may have a second groove (not shown) formed in another of the side portions 110b-1 to 110b-4. For example, the first groove and the second groove may be formed in two side portions, which are positioned opposite each other, among the side portions.

For example, the first groove 180a and the second groove may be formed in the surface of the groove 105 in the bobbin 110. Each of the first groove 180a and the second groove may overlap the groove 105 in a direction perpendicular to the outer surface of the bobbin 110, but the disclosure is not limited thereto. In another embodiment, each of the first groove 180a and the second groove may not overlap the groove 105 in a direction perpendicular to the outer surface of the bobbin 110.

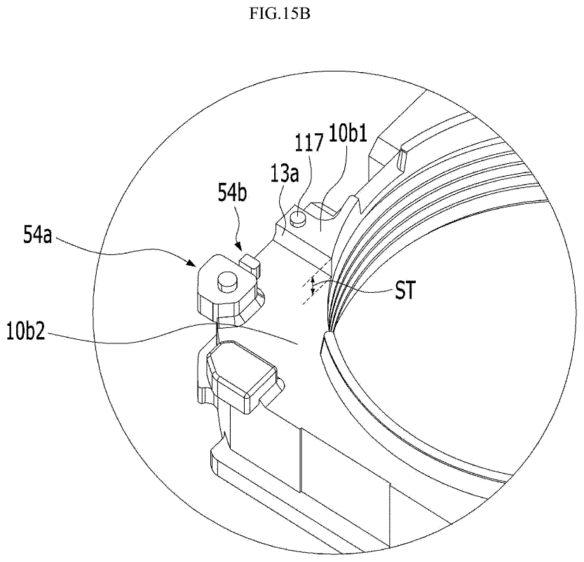

The bobbin 110 may include a first stopper (not shown), which projects upwards from the upper surface thereof, and a second stopper 118 (see FIG. 15A), which projects downwards from the lower surface thereof.

The first stopper and the second stopper of the bobbin 110 may serve to inhibit the upper surface or the lower surface of the bobbin 110 from directly colliding with the inner surface of the upper plate of the cover member 300 or the upper surface of the base 210 when the bobbin 110 is moved beyond a specified range due to an external impact or the like while the bobbin 110 is being moved in the first direction to perform auto-focusing.

Next, the coil 120 will be described.

The coil 120 may be disposed on the outer surface of the bobbin 110, and may be a drive coil configured to perform electromagnetic interaction with the magnet 130 disposed at the housing 140.

In order to create electromagnetic force resulting from the interaction between the coil and the magnet 130, a drive signal (for example, a drive current or voltage) may be applied to the coil.

The drive signal applied to the coil 120 may be a DC signal, for example, DC current (or DC voltage). In another embodiment, for example, the drive signal applied to the coil 120 may include an AC component and a DC component.

The AF operation unit may be driven unidirectionally or bidirectionally by the electromagnetic force resulting from the interaction between the coil 120 and the magnet 130. Here, unidirectional driving means that the AF operation unit is moved in one direction, for example, in an upward direction (for example, in a +z-axis direction) from the initial position of the AF operation unit, and bidirectional driving means that the AF operation unit is moved in two directions (for example, in upward and downward directions) based on the initial position of the AF operation unit.

For example, the initial position of the bobbin 110 may be the original position of the AF operation unit (for example, the bobbin) in the state in which no electric power or drive signal is applied to the coil 120, or the position at which the AF operation unit is located as the result of the upper and lower elastic members 150 and 160 being elastically deformed due only to the weight of the AF operation unit.

In addition, the initial position of the bobbin 110 may be the position at which the AF operation unit is located when gravity acts in the direction from the bobbin 110 to the base 210 or when gravity acts in the direction from the base 210 to the bobbin 110.

Here, the AF operation unit may include the bobbin 110, which is elastically supported by the upper elastic member 150 and the lower elastic member 160, and the components which are mounted on the bobbin 110 and are moved therewith. For example, the AF operation unit may include the bobbin 110, the coil 120, the sensing magnet 180, and the balancing magnet 185. For example, the AF operation unit may further include a lens (not shown) mounted on the bobbin 110.

By controlling the intensity and/or polarity (that is, the direction in which current flows) of the drive signal applied to the coil 120 and thus controlling the intensity and/or direction of the electromagnetic force resulting from the interaction between the coil 120 and the magnet 130, it is possible to control the movement of the AF operation unit and it is therefore possible to perform an auto-focusing function.

The coil 120 may be disposed at the bobbin 110 so as to have a closed cure shape (for example, a ring shape). For example, the coil 120 may be disposed on the outer surface of the bobbin 110 so as to be wound in a clockwise direction or in a counterclockwise direction about the optical axis.

In another embodiment, the coil 120 may be embodied as a coil ring, which is wound or disposed in a clockwise direction or in a counterclockwise direction about an axis perpendicular to the optical axis. Although the number of coil rings may be the same as the number of magnets 130, the disclosure is not limited thereto.

The coil 120 may be conductively connected to at least one of the upper elastic member 150 and the lower elastic member 160, and may be conductively connected to the circuit board 190 or the position sensor 170 via the upper elastic member 150 or the lower elastic member 160.

For example, the coil 120 may be coupled to the lower elastic units 160-1 and 160-2 of the lower elastic member 160 via solder or conductive adhesive.

Although the coil 120 disposed at the bobbin 110 may be in contact with the sensing magnet 180 and the balancing magnet 185, which are disposed at the bobbin 110, the disclosure is not limited thereto. In another embodiment, the coil 120 may be spaced apart from each of the sensing magnet 180 and the balancing magnet 185, which are disposed at the bobbin 110.

Furthermore, although the coil 120 disposed at the bobbin 110 may overlap each of the sensing magnet 180 and the balancing magnet 185, which are disposed at the bobbin 110, in a direction perpendicular to the optical axis, the disclosure is not limited thereto. In another embodiment, the coil 120 disposed at the bobbin 110 may not overlap each of the sensing magnet 180 and the balancing magnet 185, which are disposed at the bobbin 110, in a direction perpendicular to the optical axis.

Next, the housing 140 will be described.

The housing 140 accommodates therein the bobbin 110, at which the coil 120, the sensing magnet 180 and the balancing magnet 185 are disposed.

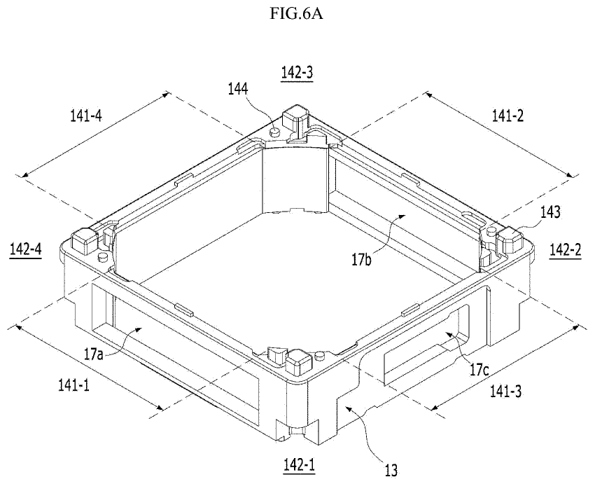

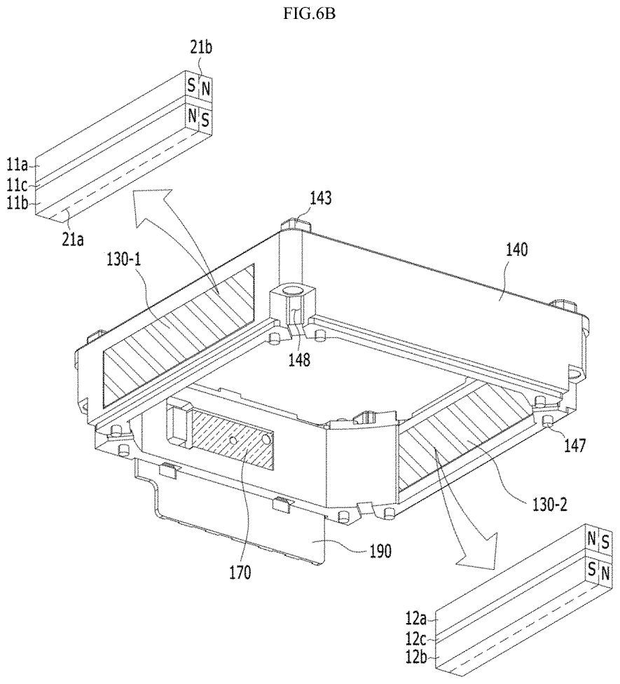

FIG. 6A is a perspective view of the housing 140 shown in FIG. 2. FIG. 6B is a perspective view of the housing 140 to which the magnet 130, the circuit board 190, and the position sensor 170 are coupled.

Referring to FIGS. 6A and 6B, the housing 140 may support the magnet 130, and may accommodate therein the bobbin 110 such that the bobbin 110 is movable in the optical-axis direction.

The housing 140 may have the shape of a column having a bore for receiving therein the bobbin 110. For example, the bore in the housing 140 may have a through-hole shape.

The housing 140 may include a plurality of first side portions (for example, 141-1 to 141-4) and a plurality of second side portions (for example, 142-1 to 142-4), which collectively define the bore.

The first side portions 141-1 to 141-4 may alternatively be referred to as side portions, and the second side portions 142-1 to 142-4 of the housing 140 may alternatively be referred to as corner portions. For example, the housing 140 may include the side portions (for example, 141-1 to 141-4) and the corner portions (for example, 142-1 to 142-4), which collectively define the bore having a polygonal shape (for example, a quadrilateral shape or an octagonal shape) or a circular shape.

The housing 140 may include a first side portion (or a first outer surface) 141-1 corresponding to the first side portion (or the first outer surface) 110b-1 of the bobbin 110, a second side portion (or a second outer surface) 141-2 corresponding to the second side portion (or the second outer surface) 110b-2 of the bobbin 110, a third side portion (or a third outer surface) 141-3 corresponding to the third side portion (or the third outer surface) 110b-3 of the bobbin 110, and a fourth side portion (or a fourth outer surface) 141-4 corresponding to the fourth side portion (or the fourth outer surface) 110b-4 of the bobbin 110.

The third and fourth side portions (or the third and fourth outer surfaces) 141-3 and 141-4 of the housing 140 may be disposed between the first and second side portions (or the first and second outer surfaces) 141-1 and 141-2 of the housing 140.

For example, each of the first to fourth outer surfaces of the housing 140 may be one outer surface of a corresponding one among the first to fourth side portions 141-1 to 141-4 of the housing 140.

Each of the first to fourth side portions 141-1 to 141-4 of the housing 140 may be disposed parallel to a corresponding one among the side plates of the cover member 300.

Each of the first to fourth corner portions 142-1 to 142-4 of the housing 140 may correspond to one of the first to fourth corner portions 110c-1 to 110c-4 of the bobbin 110.

For mounting the first and second magnets 130-1 and 130-2, the housing 140 may include a first seating portion 17a, formed in the outer surface of the first side portion 141-1 of the housing 140, and a second seating portion 17b, formed in the outer surface of the second side portion 141-2 of the housing 140.

Although each of the first and second seating portions 17a and 17b is illustrated in FIG. 6A as having therein a bore or a through hole, which is formed through the first or second side portion 141-1 or 141-2 of the housing 140, the disclosure is not limited thereto. In another embodiment, each of the first and second seating portions may have a groove or recess shape. In a further embodiment, each of the first and second seating portions may have a flat-surface shape rather than a groove shape.

In order to inhibit the housing 140 from colliding with the inner surface of the upper plate of the cover member 300, the housing 140 may be provided on the upper portion, the upper surface or the upper end thereof with a stopper 143.

Although the stopper 143 may be disposed, for example, on the upper surface of at least one of the first to fourth corner portions 142-1 to 142-4 of the housing 140, the disclosure is not limited thereto.

For coupling to a hole 152a in the first outer frame 152 of the upper elastic member 150, the housing 140 may include at least one first coupler 144 provided on the upper portion, the upper surface or the upper end thereof. Although the first coupler 144 of the housing 140 may have the shape of a protrusion, the disclosure is not limited thereto. In another embodiment, the first coupler 144 may have a groove shape or a flat-surface shape.

Furthermore, for coupling to a hole 162a in the second outer frame 162 of the lower elastic member 160, the housing 140 may include at least one second coupler 147 provided on the lower portion, the lower surface or the lower end of the housing 140. Although the second coupler 147 is illustrated in FIG. 6B as having a protrusion shape, the disclosure is not limited thereto. In another embodiment, the second coupler 147 may have a groove shape or a flat-surface shape.

In order to inhibit the lower surface or the bottom of the housing 140 from colliding with the base 210, which will be described later, the housing 140 may include at least one stopper (not shown) projecting from the lower portion, the lower surface or the lower end thereof.

The lower portion or the lower surface of at least one of the first to fourth corner portions 142-1 to 142-4 of the housing 140 may be provided therein with a guide groove 148 corresponding to a projection 216 on the base 210.

For example, the guide groove 148 in the housing 140 may be coupled to the projection 216 on the base 210 using an adhesive member, and the housing 140 may be coupled to the base 210 using an adhesive member.

For seating of the circuit board 190, the housing 140 may include a seating portion (or a seating groove) 13 provided on the outer surface of the third side portion 141-3. Although the seating portion 13 may have the shape of a groove depressed from the outer surfaces of the first and second corner portions 142-1 and 142-2, the disclosure is not limited thereto. In another embodiment, the seating portion 13 may have the shape of a flat-surface.

For example, the circuit board 190 may be attached to the third side portion 141-3 of the housing 140 using an adhesive or the like, or may have a structure (for example, a protrusion or a groove) for coupling to the housing 140.

For seating of the position sensor 170, the housing 140 may include a seating portion (or a seating groove) 17c formed in the third side portion 141-3.

For example, the seating portion 17c may be disposed in the seating portion 13 in the housing 140. Although the seating portion 17c is illustrated in FIG. 6A as having an opening or a through hole formed through the third side portion 141-3 of the housing 140, the disclosure is not limited thereto. In another embodiment, the seating portion may have a groove shape. Although the seating portion 17c may have a shape corresponding to or coinciding with the position sensor 190, the disclosure is not limited thereto.

Next, the magnet 130 will be described.

The magnet 130 may be disposed at the housing 140, and may be a magnet that is capable of generating electromagnetic force resulting from the interaction between the coil 120 and thus of moving the bobbin 110 using the electromagnetic force.

For example, the magnet 130 may include a first magnet 130-1 and a second magnet 130-2, which are disposed on the lateral surface or the outer surface of the two facing side portions 141-1 and 141-2 of the housing 140. In another embodiment, the magnet 130 may include one magnet or three or more magnets.

For example, the first magnet 130-1 may be disposed on the first lateral surface or the first outer surface of the housing 140, and the second magnet 130-2 may be disposed on the second lateral surface or the second outer surface of the housing 140. For example, the first lateral surface or the first outer surface of the housing 140 may be the lateral surface or the outer surface of the first side portion 141-1 of the housing 140, and the second lateral surface or the second outer surface of the housing 140 may be the lateral surface or the outer surface of the second side portion 141-2 of the housing 140.

The third and fourth lateral surfaces (or the third and fourth outer surfaces) of the housing 140 may be disposed between the first and second lateral surfaces (or the first and second outer surfaces) of the housing 140.

For example, the third lateral surface (or the third outer surface) of the housing 140 may be the lateral surface or the outer surface of the third side portion 141-3 of the housing 140, and the fourth lateral surface (or the fourth outer surface) of the housing 140 may be the lateral surface or the outer surface of the fourth side portion 141-4 of the housing 140.

For example, each of the first and second magnets 130-1 and 130-2 may be disposed at a corresponding one of the first seating portion 17a and the second seating portion 17b in the housing 140.

In another embodiment, the side portions 141-1 and 141-2 of the housing 140 may not have therein the opening, and the first and second magnets 130-1 and 130-2 may be disposed on the outer surfaces of the side portions 141-1 and 141-2 of the housing 140.

Although each of the first and second magnets 130-1 and 130-2 may have a shape corresponding to the outer surfaces of the side portions 141-1 and 141-2 of the housing 140, for example, a rectangular parallelepiped shape, the disclosure is not limited thereto.

Referring to FIG. 6B, each of the first and second magnets 130-1 and 130-2 may be a tetrapolar magnet including two N poles and two S poles. Here, the tetrapolar magnet may be referred to as a bipolar magnetized magnet. For example, each the first and second magnets 130-1 and 130-2 may be a bipolar magnetized magnet divided into two parts in a direction perpendicular to the optical axis. For example, each of the first and second magnets 130-1 and 130-2 may be embodied by a ferrite magnet, an alnico magnet, a rare-earth magnet or the like.

The first magnet 130-1 may include a first magnet part 11a, a second magnet part 11b and a first partition wall 11c disposed between the first magnet part 11a and the second magnet part 11b.

For example, the first partition wall 11c may be a nonmagnetic partition wall.

The first magnet part 11a may include an N pole, an S pole and a first interface 21a between the N pole and the S pole. The first interface 21a may be a portion that has substantially no magnetism and has a zone having almost no polarity, and may be a portion that is naturally formed in order to form a magnet composed of one N pole and one S pole.

The second magnet part 11b may include an N pole, an S pole and a second interface 21b between the N pole and the S pole. The second interface 21b may be a portion that has substantially no magnetism and has a zone having almost no polarity, and may be a portion that is naturally formed in order to form a magnet composed of one N pole and one S pole.

The first partition wall 11c may separate or isolate the first magnet part 11a and the second magnet part 11b from each other, and may be a portion having substantially no magnetism or polarity. For example, the first partition wall 11c may be constituted by a nonmagnetic material, air or the like. The nonmagnetic partition wall may be considered a “neutral zone”.

The first partition wall 11c may be a portion that is artificially formed when the first magnet part 11a and the second magnet part 11b are magnetized, and the width of the first partition wall 11c may be greater than the width of each of the first interface 21a and the second interface 21b. Here, the width of the first nonmagnetic partition wall 11c may be the length of the nonmagnetic partition wall 11c in a direction toward the second magnet part 11b from the first magnet part 11a.

For example, the width of the first partition wall 11c may be 0.2 mm-0.5 mm. Specifically, the width of the first partition wall 11c may be 0.3 mm-0.4 mm.

The first magnet part 11a and the second magnet part 11b may be disposed such that opposite poles thereof face each other in the optical-axis direction.

For example, the first magnet part 11a and the second magnet part 11b may be disposed such that the N pole of the first magnet part 11a and the S pole of the second magnet part 11b face the first coil 120-1. However, the disclosure is not limited thereto, and the reverse disposition is also possible.

The second magnet 130-2 may include a third magnet part 12a, a fourth magnet part 12b and a second partition wall 12c disposed between the third magnet part 12a and the fourth magnet part 12b. For example, the second partition wall 12c may be a nonmagnetic partition wall.

Each of the third magnet part 12a and the fourth magnet part 12b may include an interface between the N pole and the S pole.

The description of the first interface 21a of the first magnet part 11a may apply to the interface of each of the third magnet part 12a and the fourth magnet part 12b. Furthermore, the description of the first partition wall 11c may apply to the second partition wall 12c.

Each of the first partition wall 11c and the second partition wall 12c may extend in a horizontal direction or in a direction perpendicular to the optical axis.

The first magnet part 11a, the first partition wall 11c and the second magnet part 11b may be sequentially disposed in that order in the optical-axis direction. Furthermore, the third magnet part 12a, the second partition wall 12c and the fourth magnet part 12b may be sequentially disposed in that order in the optical-axis direction.

For example, the first magnet part 11a may be disposed on the first partition wall 11c, and the second magnet part 11b may be disposed beneath the first partition wall 11c. Furthermore, the third magnet part 12a may be disposed on the second partition wall 12c, and the fourth magnet part 12b may be disposed beneath the second partition wall 12c.

For example, each of the first partition wall 11c and the second partition wall 12c may be parallel to a line perpendicular to the optical axis, and the interface 21a or 21b of each of the first and second magnet parts 11a and 11b may be parallel to the optical axis.

In another embodiment, each of the first and second magnets 130-1 and 130-2 may be a monopolar magnetized magnet having one N pole and one S pole.

Next, the sensing magnet 180 will be described.

The position sensor 180 may detect variation in the intensity of a magnetic field of the sensing magnet 180 due to movement of the bobbin 110.

The sensing magnet 180 may be disposed at one of the third and fourth side portions (or the third and fourth outer surfaces) 110b-4 of the bobbin 110.

For example, the sensing magnet 180 may be disposed on the third side portion (or the third outer surface) 110b-3 of the bobbin 110. For example, the sensing magnet 180 may be disposed in the seating portion 180a in the bobbin 110.

Although a portion of one surface of the sensing magnet 180 mounted in the seating portion 180a in the bobbin 110 may project from the outer surface or the lower surface of the bobbin 110, the disclosure is not limited thereto. In another embodiment, the portion may not project from the outer surface of the bobbin 110.

The sensing magnet 180 may be a monopolar magnetized magnet, which is disposed such that the upper surface thereof has an N pole and the lower surface thereof has an S pole. However, the disclosure is not limited thereto, and the polarities may be disposed in the opposite arrangement.

For example, the sensing magnet 180 may be disposed such that the interface between the N pole and the S pole is parallel to a direction perpendicular to the optical axis. However, the disclosure is not limited thereto, and the interface between the N pole and the S pole may be parallel to the optical axis in another embodiment.

In another embodiment, the sensing magnet 180 may be a bipolar magnetized magnet. The bipolar magnetized magnet may include a first magnet part including an N pole and an S pole, a second magnet part including an N pole and an S pole, and a partition wall (for example, a nonmagnetic partition wall) disposed between the first magnet part and the second magnet part.

By virtue of the electromagnetic force resulting from the interaction between the coil 120 and the first and second magnets 130-1 and 130-2, the sensing magnet 180 may be moved together with the bobbin 110 in the optical-axis direction OA. At this time, the position sensor 170 may detect the intensity of the magnetic field of the sensing magnet 180, which is moved in the optical-axis direction, and may output an output signal corresponding to the detected intensity. For example, a controller 830 of a camera module 200 or a controller 780 of a terminal 200A may detect displacement of the bobbin 110 in the optical-axis direction based on the output signal output from the position sensor 170.

The balancing magnet 185 may serve to counteract the influence on the magnet 130 or the coil 120 due to the magnetic field of the sensing magnet 180 and to attain weight equilibrium with respect to the AF operation unit.

The balancing magnet 185 may be disposed at the other of the third and fourth side portions (or the third and fourth outer surfaces) 110b-3 and 110b-4 of the bobbin 110. For example, the balancing magnet 185 may be disposed at the fourth side portion (or the fourth outer surface) 110b-4 of the bobbin 110.

Next, the position sensor 170 and the circuit board 190 will be described.

The circuit board 190 and the position sensor 170 may be disposed on the third side portion or the fourth side portion of the housing 140, at which the first and second magnets 130-1 and 130-2 are not disposed. For example, the circuit board 190 and the position sensor 170 may be disposed on the third side portion (or the third outer surface) 141-3.

For example, the circuit board 190 may be disposed in the seating portion 13 formed in the third side portion 141-3 of the housing 140. A first surface of the circuit board 190 may be in contact with the seating portion 13 in the housing 140.

The circuit board 190 may include a plurality of terminals 190-1 to 190-6, which are to be conductively connected to external components. Although the plurality of terminals 190-1 to 190-6 may be arranged in a line at the lower end of the second surface of the circuit board 190, the disclosure is not limited thereto. Here, the second surface of the circuit board 190 may be a surface opposite the first surface of the circuit board 190.

Although the circuit board 190 according to the embodiment shown in FIG. 3 includes six terminals 190-1 to 190-6, the disclosure is not limited thereto.

The circuit board 190 may include pads and a circuit pattern (or a wire) for conductively connecting the position sensor 190 to the terminals 190-1 to 190-6.

The position sensor 170 may be mounted or disposed on the first surface of the circuit board 190.

The position sensor 170 may be disposed at the seating portion 17c formed in the third side portion 141-3 of the housing 140.

At the initial position of the bobbin 110, the position sensor 170 disposed at the housing 140 may overlap the sensing magnet 180, disposed at the bobbin 110, in a direction toward the fourth side portion 141-4 of the housing 140 from the third side portion 141-3 of the housing 140. However, the disclosure is not limited thereto.

In another embodiment, at the initial position of the bobbin 110, the position sensor 170 and the sensing magnet 180 may not overlap each other in a direction toward the fourth side portion 141-4 of the housing 140 from the third side portion 141-3 of the housing 140.

At the initial position of the bobbin 110, the position sensor 170 disposed at the housing 140 may overlap the coil 120 in the direction of the fourth side portion 141-4 of the housing 140 from the third side portion 141-3 of the housing 140. However, the disclosure is not limited thereto, and the position sensor 170 may not overlap the coil 120.

The sensor 170 disposed at the housing 140 may not overlap the first magnet 130-1 or the second magnet 130-2 in a direction toward the fourth side portion 141-4 of the housing 140 from the third side portion 141-3 of the housing 140.

The position sensor 170 may detect the intensity of the magnetic field of the sensing magnet 180 mounted on the bobbin 110, and may output the output signal (for example, the output voltage) corresponding to the detected intensity.

The position sensor 170 may be embodied as a hall sensor or a driver including a hall sensor.

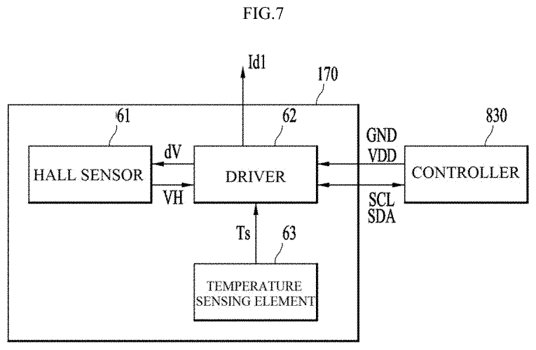

FIG. 7 illustrates an embodiment of the position sensor 170 shown in FIG. 2.

Referring to FIG. 7, the position sensor 170 may include a hall sensor 61 and a driver 62.

For example, the hall sensor 61 may be made of silicone, and the output VH of the hall sensor 61 may increase as the ambient temperature increases. For example, the ambient temperature may be the temperature of the lens moving apparatus, for example, the temperature of the circuit board 190, the temperature of the hall sensor 61, or the temperature of the driver 62.

In another embodiment, the hall sensor 61 may be made of GaAs, and the output VH of the hall sensor 61 may have a slope of about −0.06%/° C. with respect to an ambient temperature.

The position sensor 170 may further include a temperature-sensing element 63 capable of detecting an ambient temperature. The temperature-sensing element 63 may output a temperature detection signal Ts, corresponding to the result of detection of the ambient temperature around the position sensor 170, to the driver 62.

For example, the hall sensor 61 of the position sensor 170 may generate the output VH corresponding to the result of detection of the intensity of the magnetic force of the sensing magnet 180.

The driver 62 may output a drive signal dV for driving the hall sensor 61 and a drive signal Id1 for driving the coil 120.

For example, the driver 62 may receive a clock signal SCL, a data signal SDA, and power signals VCC and GND from the controllers 830 and 780 through data communication using a protocol such as I2C communication.

The driver 62 may create the clock signal SCL, the drive signal dV for driving the hall sensor 61 using the power signals VCC and GND, and the drive signal Id1 for driving the coil 120.

The position sensor 170 may include the first to fourth terminals for sending and receiving the clock signal SCL, the data signal SDA, the power signals VCC and GND, and the fifth and sixth terminals for providing a drive signal to the coil 120.

The circuit board 190 may be conductively connected to the first to sixth terminals (not shown) of the position sensor 170. The circuit board 190 may include a first terminal (or a first pad) 91, which is conductively connected to the fifth terminal of the position sensor 170, and a second terminal (or a second pad) 92, which is conductively connected to the sixth terminal of the first position sensor 170.

Furthermore, the driver 62 may receive the output VH of the hall sensor 61, and may send the clock signal SCL and the data signal SDA pertaining to the output VH of the hall sensor 61 through data communication using a protocol such as I2C communication.

Furthermore, the driver 62 may receive the temperature detection signal Ts as a result of detection by the temperature-sensing element 63, and may send the temperature detection signal Ts to controllers 830 and 780 through data communication using a protocol such as I2C communication.

The controllers 830 and 780 may perform temperature compensation for the output VH from the hall sensor 61 based on variation in the ambient temperature detected by the temperature-sensing element 63 of the position sensor 170.

The position sensor 170 may include the first to third terminals for the clock signal SCL and the two power signals VCC and GND, the fourth terminal for the data SDA, and the fifth and sixth terminals for providing drive signals to the coil 120.

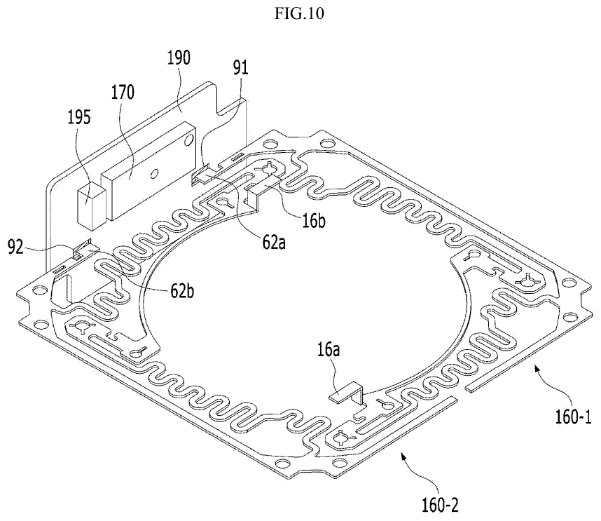

Referring to FIG. 10, the lens moving apparatus 100 may further include a capacitor 195 disposed or mounted on the circuit board 190. The capacitor 195, which has a chip shape or a condenser shape, may be disposed or formed at the circuit.

The capacitor 195 may be connected in parallel to terminals, which are configured to provide the position sensor 170 with a drive signal or power signals VCC and GND. By virtue of the capacitor 195, a drive signal may be stably and consistently provided to the position sensor 170. The capacitor 195 may alternatively be referred to as a “capacitive device” or a “condenser”.

In another embodiment, the capacitor 195 may be connected in parallel to the terminals in parallel, which are configured to output output signals of the position sensor 170.

Next, the upper elastic member 150 and the lower elastic member 160 will be described.

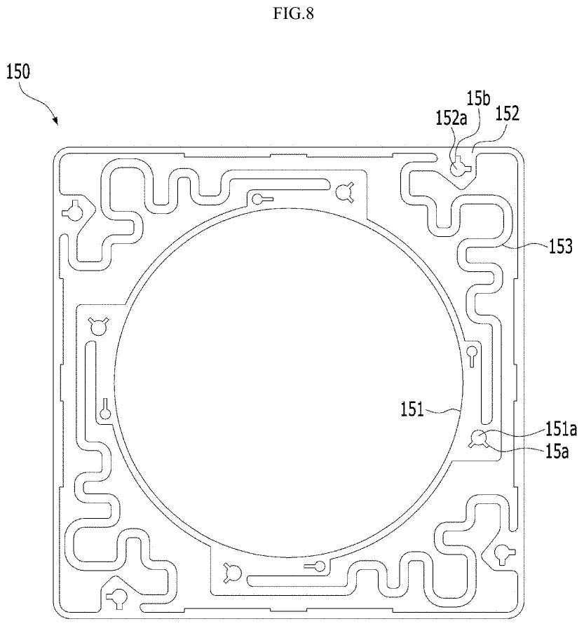

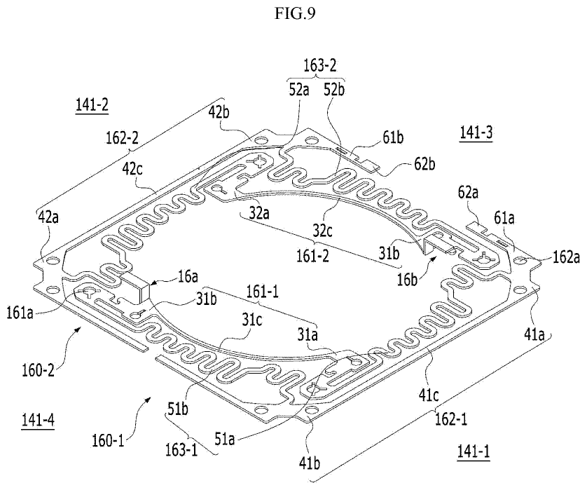

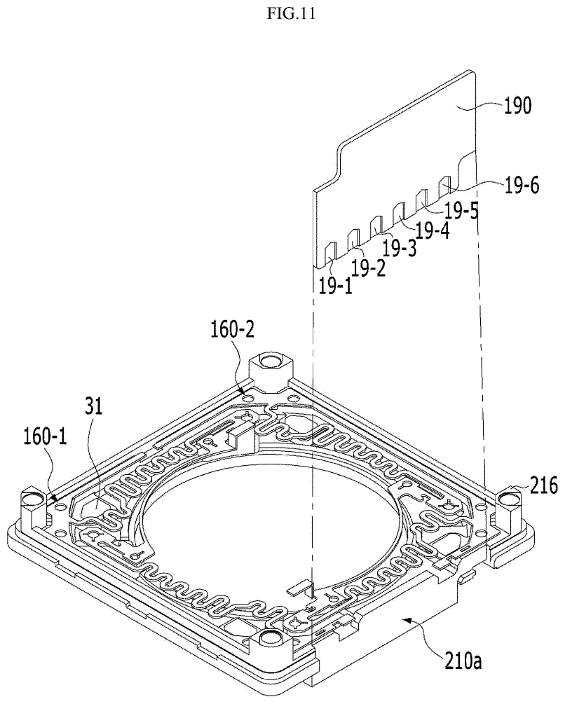

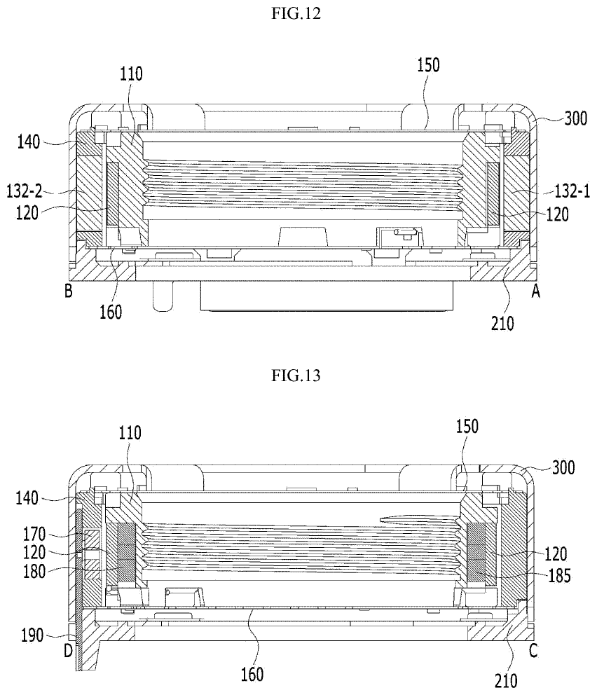

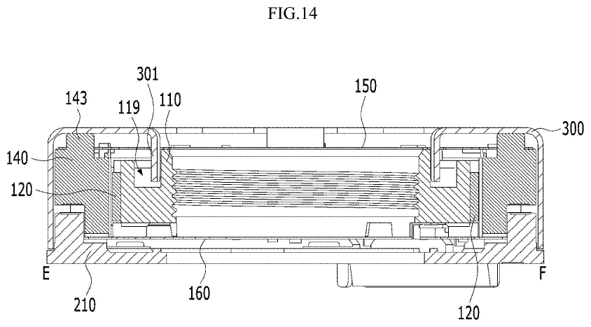

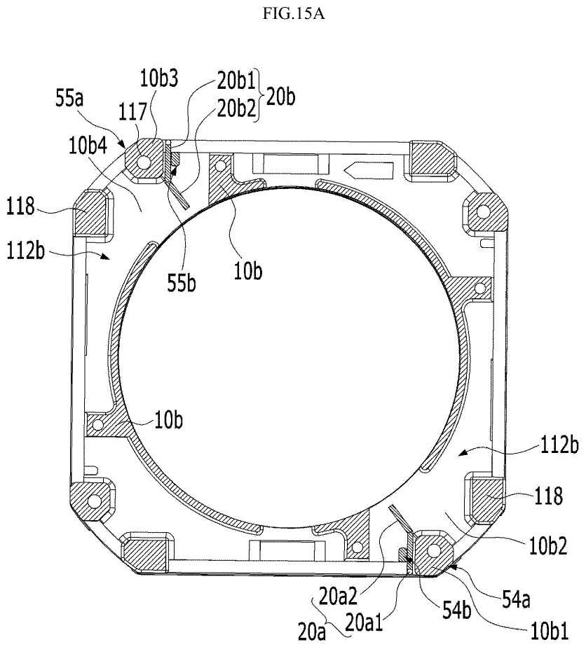

FIG. 8 is a plan view of the upper elastic member 150. FIG. 9 is a perspective view of the lower elastic member 160. FIG. 10 illustrates the circuit board 190 and the connection between the first and second lower elastic units 160-1 and 160-2. FIG. 11 is a view illustrating the lower elastic member 160, the base 210 and the circuit board 190. FIG. 12 is a cross-sectional view of the lens moving apparatus 100 shown in FIG. 3, taken along line A-B. FIG. 13 is a cross-sectional view of the lens moving apparatus 100 shown in FIG. 3, taken along line C-D. FIG. 14 is a cross-sectional view of the lens moving apparatus 100 shown in FIG. 3, taken along line E-F.

Referring to FIGS. 8 and 14, each of the upper elastic member 150 and the lower elastic member 160 is coupled both to the bobbin 110 and to the housing 140 so as to support the bobbin 110.

For example, the upper elastic member 150 may be coupled both to the upper portion, the upper surface or the upper end of the bobbin 110 and to the upper portion, the upper surface or the upper end of the housing 140, and the lower elastic member 160 may be coupled both to the lower portion, the lower surface or the lower end of the bobbin 110 and to the lower portion, the lower surface or the lower end of the housing 140.

At least one of the upper and lower elastic members 150 and 160 may be divided or separated into two or more.

The upper elastic member 150 may include at least one upper elastic unit. Although the upper elastic member 150 is illustrated in FIG. 9 as having a single upper elastic unit, which is not divided, the disclosure is not limited thereto. In another embodiment, the upper elastic member may include a plurality of upper elastic units.

Although each of the upper elastic member 150 and the lower elastic member 160 may be embodied as a leaf spring, the disclosure is not limited thereto. Each of the upper and lower elastic members 150 and 160 may be embodied as a coil spring, a suspension wire or the like.

The upper elastic member 150 may include a first inner frame 151 coupled to the upper portion, the upper surface or the upper end of the bobbin 110, a first outer frame 152 coupled to the upper portion, the upper surface or the upper end of the housing 140, and a first frame connector 153 connecting the first inner frame 151 to the first outer frame 152. Here, the term “inner frame” may be interchangeably used with “inner portion”, and the term “outer frame” may be interchangeably used with “outer portion”. The term “frame connector” may be interchangeably used with “connector”.

The first inner frame 151 of the upper elastic member 150 may have formed therein a hole 151a, which is coupled to the first coupling portion 113 of the bobbin 110, and the first outer frame 152 may have formed therein a hole 152a, which is coupled to the first coupler 113 of the housing 140.

Each of the holes 151a and 152a may have a cut portion 15a or 15b, which allows adhesive for coupling the first coupler of the bobbin 110 and the first coupler of the housing 140 to the upper elastic member 150 to easily infiltrate therein.

For example, the first inner frame 151 may include a first frame, disposed at the first side portion 110b-1 of the bobbin 110, a second frame, disposed at the second side portion 110b-2 of the bobbin 110, a third frame 151-3, disposed at the third side portion 110b-3 of the bobbin 110, and a fourth frame, disposed at the fourth side portion 110b-4 of the bobbin 110. For example, the first to fourth frames of the first inner frame 151 may be coupled to the first coupler 113 of the bobbin 110.

For example, the first inner frame 151 may further include connectors for connecting the first to fourth frames of the first frame 151 to one another.

For example, the outer frame 152 may include a first frame disposed at the first corner portion 142-1 of the housing 140, a second frame disposed at the second corner portion 142-2 of the housing 140, a third frame disposed at the third corner portion 142-3 of the housing 140, and a fourth frame disposed at the fourth corner portion 142-4 of the housing 140. The first to fourth frames of the first outer frame 152 may be coupled to the first coupler 144 of the housing 140.

For example, the first outer frame 152 may further include connectors for connecting the first to fourth frames of the first outer frame 152 to one another.

For example, the upper elastic member 150 may include four first frame connectors 153. Each of the four first frame connectors 153 may connect a corresponding one of the first to fourth frames of the first inner frame 151 to a corresponding one of the first to fourth frames of the first outer frame 152.

The lower elastic member 160 may include a body (for example, the second outer frame 162), and extensions (for example, 16a and 16b), which extend from the body (for example, the second outer frame 162).

The bobbin 110 may include a first surface (for example, 10b1) and a second surface (for example, 10b2), which define a height difference therebetween in the optical-axis direction.

For example, the first surface (for example, 10b1) of the bobbin 110 and the second surface (for example, 10b2) of the bobbin 110 may be formed at different levels.

The body (for example, the second outer frame 162) may be disposed on the first surface (for example, 10b1) of the bobbin 110. For example, a portion of the body may be disposed on the first surface (for example, 10b1) of the bobbin 110.

The extension (for example, 16a) may be coupled to the coil 120 and may include a first region (or a “first portion”) (for example, 71), which is bent in a direction toward the second surface (for example, 10b2) of the bobbin 110 from the body (for example, the second outer frame 162-1).

For example, the extension (for example, 16a) may be disposed on the second surface (for example, 10b2) of the bobbin 110, and may be coupled to the coil 120.

The extension (for example, 16a) may include a second region (or a “second portion”) (for example, 72), which is bent from the first region (for example, 71) and is disposed on the second surface (for example, 10b2) of the bobbin 110.

The coil 120 may be conductively connected to the extensions (for example, 16a and 16b) through soldering. The bobbin 110 may include a third surface 10b3 and a fourth surface 10b4, which define a height difference therebetween in the optical-axis direction. For example, the third surface (for example, 10b3) and the fourth surface (for example, 10b4) of the bobbin 110 may be formed at different levels.

The lower elastic member 160 may include at least one lower elastic unit.

For example, the lower elastic member 160 may include a first lower elastic unit 160-1 and a second lower elastic unit 160-1, which are spaced apart from each other. The term “elastic unit” may be interchangeably used with “spring”.

For example, the first lower elastic unit 160-1 may include a first body (for example, a second outer frame 162-1) coupled to the first surface 10b1 of the bobbin 110, and the first extension (for example, 16a), which extends from the first body (for example, the second outer frame 162-1) and is bent toward the second surface 10b2 of the bobbin 110.

For example, the second lower elastic unit 160-2 may include a second body (for example, a second outer frame 162-2) coupled to the third surface 10b3 of the bobbin 110, and the second extension (for example, 16b), which extends from the second body (for example, the second outer frame 162-2) and is bent toward the fourth surface 10b-4 of the bobbin 110.

For example, the second surface 10b2 and the fourth surface 10b4 of the bobbin 110 may be flush with each other. For example, the second surface 10b2 and the fourth surface 10b4 of the bobbin 110 may be the same surface. In this case, the first surface 10b1 and the third surface 10b3 of the bobbin 110 may be referred to as the first surface of the bobbin 110, and the second surface 10b2 and the fourth surface 10b4 may be referred to as the second surface of the bobbin 110.

Although the lower surface of the stopper 118 of the bobbin 110 may be lower than the first surface 10b1 and the third surface 10b3, the disclosure is not limited thereto. In another embodiment, the lower surface of the stopper 118 of the bobbin 110 and the first surface 10b1 and the third surface 10b3 may be positioned at the same height, and may be flush with each other.

The first and second lower elastic units 160-1 and 160-2 may be coupled to the bobbin 110. Alternatively, the first and second lower elastic units 160-1 and 160-2 may be coupled both to the bobbin 110 and to the housing 140. The first and second lower elastic units 160-1 and 160-1 may be disposed between the bobbin 110 and the base 210.

At least one of the first and second lower elastic units 160-1 and 160-2 may include the second inner frame 161-1, 161-2 coupled to the lower portion, the lower surface or the lower end of the bobbin 110, the second outer frame 162-1, 162-2 coupled to the lower portion, the lower surface or the lower end of the housing 140, and the second frame connector 163-1, 163-2 connecting the second inner frame 161-1, 161-2 to the second outer frame 162-1, 162-2.

In another embodiment, the second outer frame of at least one of the first and second lower elastic units 160-1 and 160-2 may be coupled to the base 210. In another embodiment, the second outer frame of at least one of the first and second lower elastic units 160-1 and 160-2 may be coupled to the upper surface of the base 210.

The second inner frame 161-1, 161-2 of at least one of the first and second lower elastic units 160-1 and 160-2 may have formed therein a hole 161a for coupling the second coupling portion 117 of the bobbin 110 using solder or a conductive adhesive member.

The second outer frame 162-1, 162-2 of at least one of the first and second lower elastic units 160-1 and 160-2 may have formed therein a hole 162a for coupling the second coupler 147 of the housing 140. Each of the holes 161a and 162a may have a cut portion configured to allow adhesive for coupling the second coupler of the bobbin and the second coupler of the housing 140 to the lower elastic member 160 to easily infiltrate.

The second inner frame 161-1 of the lower elastic unit 160-1 may include at least one frame coupled to the second coupler 117 of the bobbin 110.

For example, the second inner frame 161-1 may include first and second frames 31a and 31b coupled to the second coupler 117 of the bobbin 110 and a third frame 31c connecting the first and second frames 31a and 31b to each other. For example, the third frame 31c may have a curved shape.

For example, the second inner frame 161-1 may be disposed at the lower portions or lower surfaces of the fourth side portion 110b-4, the fourth corner portion 110c-4 and the first side portion 110b-1 of the bobbin 110.

The second inner frame 161-2 of the second lower elastic unit 160-2 may include at least one frame coupled to the second coupler 117 of the bobbin 110.

For example, the second inner frame 161-2 may include first and second frames 32a and 32b coupled to the second coupler 117 of the bobbin 110 and a third frame 32c connecting the first and second frames 32a and 32b to each other. For example, the third frame 32c may have a curved shape.

For example, the second inner frame 161-2 may be disposed at the lower portions or lower surfaces of the third side portion 110b-3, the second corner portion 110c-2 and the second side portion 110b-2 of the bobbin 110.

The second outer frame 162-1 of the first lower elastic unit 160-1 may include at least one frame coupled to the second coupler 147 of the housing 140.

For example, the second outer frame 162-1 may include first and second frames 41a and 41b coupled to the second coupler 147 of the housing 140 and a third frame 41c connecting the first and second frames 41a and 41b to each other. Although the third frame 41c may have, for example, a linear shape, the disclosure is not limited thereto. In another embodiment, the third frame 41c may have a curved shape.

For example, the second outer frame 162-1 may be disposed at the lower portions or lower surfaces of the fourth side portion 141-4, the fourth corner portion 142-4, the first side portion 141-1, the first corner portion 142-1 and the third side portion 141-3 of the housing 140.

The second outer frame 162-2 of the second lower elastic unit 160-2 may include at least one frame coupled to the second coupler 147 of the housing 140.

For example, the second outer frame 162-2 may include first and second frames 42a and 42b coupled to the second coupler 147 of the housing 140 and a third frame 42c connecting the first and second frames 42a and 42b to each other. Although the third frame 42c may have, for example, a linear shape, the disclosure is not limited thereto. In another embodiment, the third frame 42c may have a curved shape.

For example, the second outer frame 162-2 may be disposed at the lower portions or lower surfaces of the fourth side portion 141-4, the third corner portion 142-3, the second side portion 141-2, the second corner portion 142-2, and the third side portion 141-3 of the housing 140.

The second frame connector 163-1 of the first lower elastic unit 160-1 may include a first connector 51a connecting the first frame 31a of the second inner frame 161-1 to the first frame 41a of the second outer frame 162-1 and a second connector 51b connecting the second frame 31b of the second inner frame 161-1 to the second frame 41b of the second outer frame 162-1.

The second frame connector 163-2 of the second lower elastic unit 160-2 may include a first connector 52a connecting the first frame 32a of the second inner frame 161-2 to the first frame 42a of the second outer frame 162-2 and a second connector 52b connecting the second frame 32b of the second inner frame 161-2 to the second frame 42b of the second outer frame 162-2.

The second outer frame 162-1 of the first lower elastic unit 160-1 may include a first extension 61a, which is connected to the first frame 41a and extends toward the third side portion 141-3 of the housing 140 from the first corner portion 141-1 of the housing 140, and a first bonding portion 62a, which is provided at one end of the first extension 61a and is connected to the first terminal 91 of the circuit board 190.

For example, the first bonding portion 62a may be positioned under the lower surface or the lower portion of the third side portion 141-3 of the housing 140.

The second outer frame 162-2 of the second lower elastic unit 160-2 may include a second extension 61b, which is connected to the second frame 42b and extends toward the third side portion 141-3 of the housing from the second corner portion 141-2 of the housing 140, and a second bonding portion 62b, which is provided at one end of the second extension 61b and is connected to the second terminal 92 of the circuit board 190.

For example, the second bonding portion 62b may be positioned under the lower surface or the lower portion of the third side portion 141-3 of the housing 140.

For example, each of the first and second bonding portions 62a and 62b may have a structure projecting toward the circuit board 190 from the outer surface of the second outer frame 162-1, 162-2 positioned at the third side portion 141-3 for easy coupling to the first or second terminal 91, 92 of the circuit board 190.

The second inner frame 161-1 of the first lower elastic unit 160-1 may include the first extension 16a, to which one end of the coil 120 is coupled or bonded via conductive adhesive or solder, and the second inner frame 161-2 of the second lower elastic unit 160-2 may include the second extension 16b, to which the other end of the coil 120 is coupled or bonded.

Here, the first extension 16a may alternatively be referred to as a first bonding portion or a first coupler, and the second extension 16b may alternatively be referred to as a second bonding portion or a second coupler.

For example, the first extension 16a of the first lower elastic unit 160-1 may be disposed at the second frame 31b of the second inner frame 161-1, and may extend upwards from one end of the second frame 31b.

For example, the second extension 16b of the second lower elastic unit 160-2 may be disposed at the second frame 32b of the second inner frame 161-2, and may extend upwards from one end of the second frame 32b.

Each of the first frame connector 153 of the upper elastic member 150 and the second frame connectors 163-1 and 163-2 of the lower elastic member 160 may be bent or curved (or rounded) at least once so as to form a pattern having a predetermined shape. Upward and/or downward movement of the bobbin 110 in the first direction may be resiliently (or elastically) supported by positional variation and fine deformation of the first and second frame connectors 153, 163-1 and 163-2.

When the position sensor 170 is that of the embodiment shown in FIG. 7, the position sensor 170 may include the six terminals as described above. The first to fourth terminals of the position sensor 170 may be conductively connected to the four external terminals (for example, 19-1 to 19-4) of the circuit board 190 so as to send or receive a clock signal SCL, a data signal SDA, and power signals VCC and GND.

The fifth and sixth terminals of the position sensor 170 may be conductively connected to the first and second terminals (or the first and second pads) 91 and 92 of the circuit board 190, and the position sensor 170 may provide a drive signal or power to the coil 120 via the first and second terminals 91 and 92 of the circuit board 190 and the first and second lower elastic units 160-1 and 160-2.

When the position sensor 170 includes only the hall sensor, the position sensor 170 may include two input terminals and two output terminals. Here, the input terminals and the output terminals of the position sensor 170 of the position sensor 170 may be conductively connected to four external terminals (for example, 19-1 to 19-4) among the six external terminals 19-1 to 19-6 of the circuit board 190.

Two external terminals 19-5 and 19-6 of the circuit board 190 may receive a drive signal or power from the outside, and the two external terminals 19-5 and 19-6 of the circuit board 190 may be conductively connected to the first and second terminals (or the first and second pads 91 and 92) of the circuit board 190. The drive signal or power may be provided to the coil 120 via the first and second terminals 91 and 92 and the first and second lower elastic units 160-1 and 160-2.

In order to absorb and dampen vibrations of the bobbin 110, the lens moving apparatus 100 may further include a damper (not shown) disposed between the upper elastic member 150 and the housing 140.

For example, the damper (not shown) may be disposed in the space between the first frame connector 153 of the upper elastic member 150 and the bobbin 110 (and/or the housing 140).

For example, the lens moving apparatus 100 may further include a damper (not shown) disposed between the second frame connectors 163-1 and 163-2 of the first and second lower elastic units 160-1 and 160-2 and the bobbin 110 (and/or the housing 140).

For example, a damper (not shown) may also be disposed between the inner surface of the housing 140 and the outer surface of the bobbin 110.

Next, the base 210 will be described.

Referring to FIG. 11, the base 210 may have a bore corresponding to the bore in the bobbin 110 and/or the bore in the housing 140, and may have a shape corresponding to or coinciding with that of the cover member 300, for example, a quadrilateral shape. For example, the bore in the base 210 may have a through-hole shape.

The lower end of the lateral surface of the base 210 may include a step 211, to which an adhesive is applied when the cover member 300 is secured to the base 210 via adhesion. Here, the step 211 may guide the cover member 300, which is coupled to the upper side of the base, and may face the lower end of the side plate of the cover member 300. An adhesive member and/or a sealing member may be disposed or applied between the lower end of the side plate of the base 210 and the step 211 of the base 210.

The base 210 may be disposed below the bobbin 110 and the housing 140.

For example, the base 210 may be disposed below the lower elastic member 160.

The projection 216, which corresponds to the guide groove 148 in the housing 140, may be provided at a corner of the upper surface of the base 210. Although the projection 216 may have the form of a polygonal column, which projects perpendicularly from the upper surface of the base 210, the disclosure is not limited thereto.

For example, the projection 216 may be fitted into the guide groove 148 in the housing 140, and may be fastened or coupled to the guide groove 148 using an adhesive member (not shown) such as epoxy or silicone.

The base 210 may include stoppers 31 projecting from the upper surface thereof.

Although the stoppers 31 may be disposed so as to correspond to the projections 216, the disclosure is not limited thereto. The stoppers 31 may be disposed at positions corresponding to the second frame connectors 163-1 and 163-2 of the first and second lower elastic units 160-1 and 160-2.

In order to avoid spatial interference between the bobbin 110 and the lower elastic member 160, the stoppers 231 of the base 210 may be positioned higher than the second frame connectors 163-1 and 163-2 of the lower elastic units 160-1 and 160-2 coupled to the base 210. The stoppers 231 of the base 210 are able to inhibit the lower surface or the lower end of the bobbin 210 from directly colliding with the upper surface of the base 210 when an external impact occurs.

The base 210 may include a seating groove 210a formed in the lateral surface corresponding to the side portion (for example, 141-4) of the housing 140, at which the circuit board 190 is disposed, so as to allow the lower end of the circuit board 190 to be seated in the seating groove 210a.

For example, the terminals 19-1 to 19-6 of the circuit board 190 may be disposed at the lower end of the second surface of the circuit board 190, and may be positioned in the seating groove 210a.

Next, the cover member 300 will be described.

The cover member 300 accommodates other components 110, 120, 130, 140, 150, 160, 170, 180, 185 and 190 in the space defined between the cover member 300 and the base 210.

The cover member 300 may be configured to have a box shape, which is open at the lower surface thereof and includes the upper plate and the side plates. The lower ends of the side plates of the cover member 300 may be coupled to the upper portion of the base 1210. The upper plate of the cover member 300 may have a polygonal shape, for example, a quadrilateral shape, an octagonal shape, or the like. The upper plate of the cover member 300 may have a bore through which a lens (not shown) is exposed to external light.

The cover member 300 may be made of a nonmagnetic material such as stainless steel or plastic in order to inhibit the cover member 300 from being attracted to the magnet 130. However, the cover member 300 may alternatively be made of a magnetic material so as to serve as a yoke.

The cover member 300 may include at least one projection 301, which extends toward the upper surface of the bobbin from an area of the bore formed in the upper plate thereof. The at least one projection 301 may be disposed in a groove formed in the upper surface of the bobbin 110. The at least one projection 301 of the cover member 300 may serve as a yoke.

Since the at least one projection 301 may come into contact with the bottom surface of the groove 119 in the bobbin 110 at the time of AF operation, the projection 301 may serve as a stopper for restricting the upward movement of the bobbin 110 within a predetermined range.

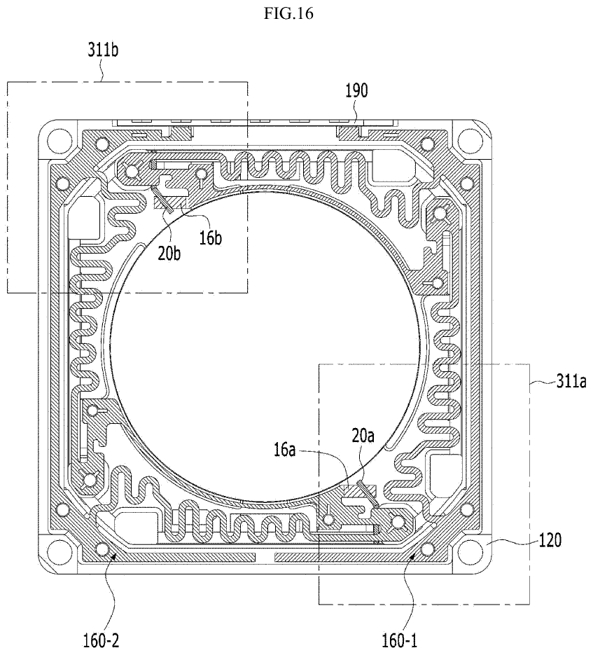

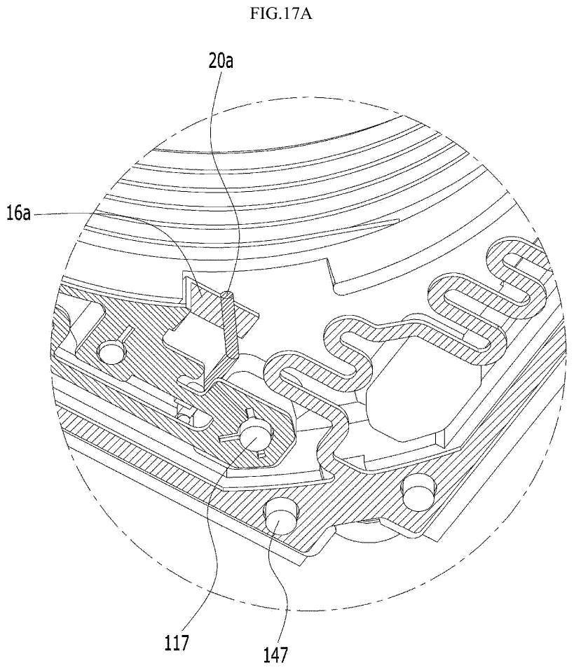

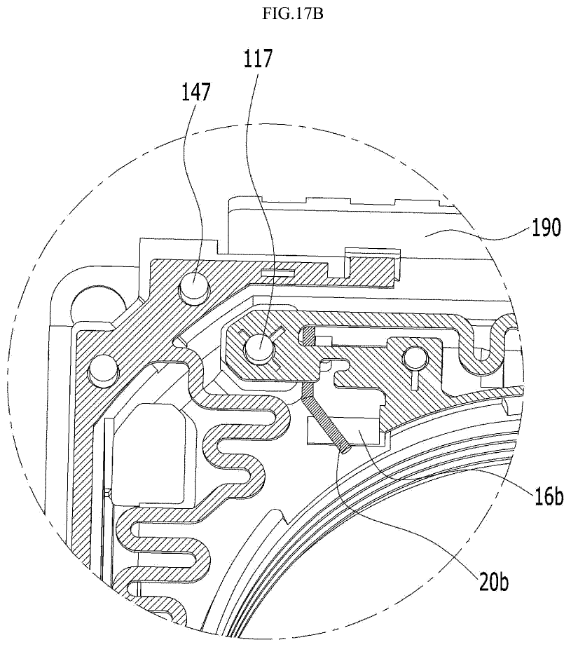

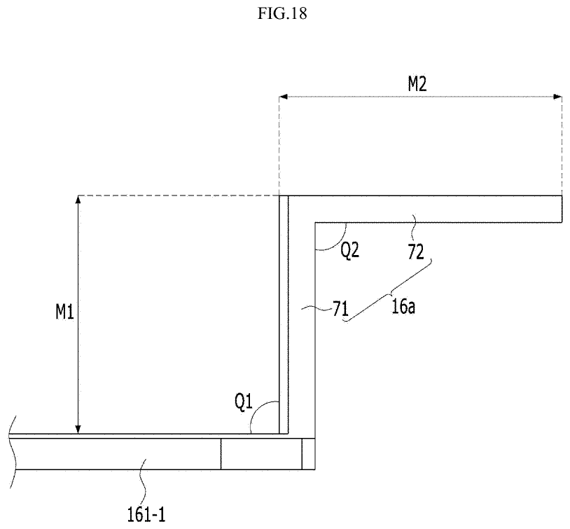

FIG. 15A is a view illustrating one end 20a and the other end 20b of the coil 120 disposed on the lower surface of the bobbin 110. FIG. 15B is an enlarged view of a portion of the lower surface of the bobbin 110. FIG. 16 is a bottom view of the lens moving apparatus 100 shown in FIG. 3, from which the base 210 is removed. FIG. 17A is a view illustrating a first dotted portion 311a in FIG. 16. FIG. 17B is a view illustrating a second dotted portion 311b in FIG. 16. FIG. 18 is an enlarged view of the first extension 16a.

Referring to FIGS. 15A to 18, the bobbin 110 may include the first surface 10b1, to which the first and second lower elastic units 160-1 and 160-2 are coupled, and the second surface 10b2, having a height difference ST (hereinafter, referred to as a “second height difference”) from the first surface 10b1 in the optical-axis direction.

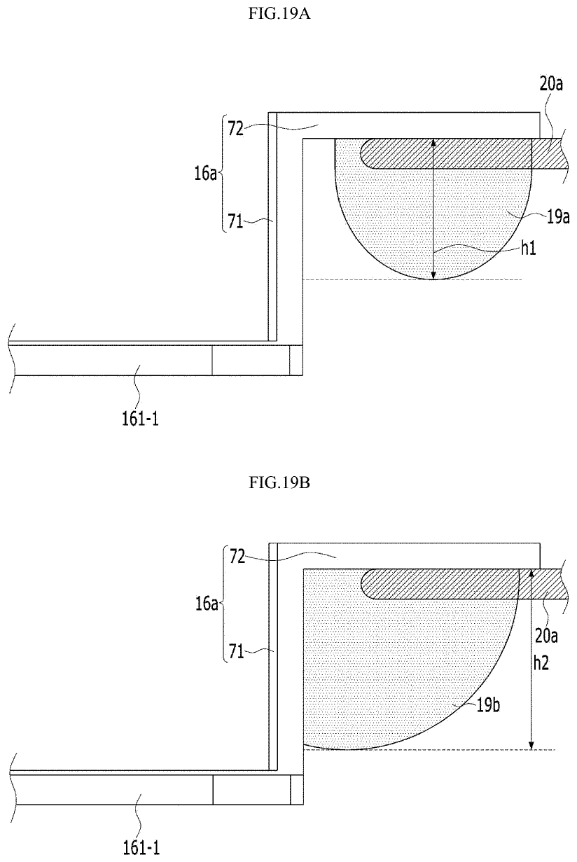

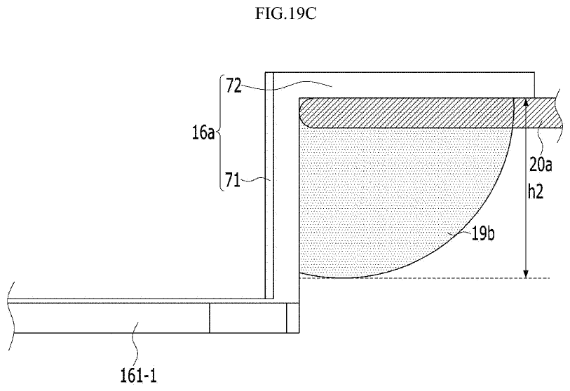

For example, the second height difference ST between the first surface 10b1 and the second surface 10b2 may be 0.3 mm-0.5 mm. Here, the second height difference ST may be larger than the above-mentioned first height difference. The reason for this is because all of motion of the second frame connectors 163-1 and 163-2 of the lower elastic unit 160-1 and 160-2 caused by movement of the bobbin 110, and the height of the first and second solders 19a and 19b (see FIGS. 19A to 19C) required to couple the coil 120 to the extensions 16a and 16b must be considered.

Because the height of the solde 19a, 19b (see FIGS. 19A to 19C) is about 0.3 mm, it is possible to reduce the size of the lens moving apparatus in the optical-axis direction by at least the height h1, h2 of the solder 19a, 19b when the height h1, h2 of the solder 19a, 19b coupled to the extension 16a, 16b is equal to or smaller than the height difference ST.

The solder 19a, 19b coupled to the extension 16a, 16b may not project downwards beyond the first surface 10b1 of the bobbin 110. In other words, the solder 19a, 19b coupled to the extension 16a, 16b may not project downwards beyond the lower surface of the second inner frame 161-1 of the lower elastic unit 160-1, 160-2 coupled to the first surface 10b1 of the bobbin 110.

For example, the height h1, h2 of the solder 19a, 19b may be smaller than the second height difference ST. Here, the height h1, h2 of the solder 19a, 19b may be the maximum length of the solder 19a, 19b in the optical-axis direction.

The height of first solder 19a or the height of the second solder 19b may be equal to or less than the length of the first region of the first extension 16a. Specifically, the height h1, h2 of the solder 19a, 19b may be equal to or less than the length M1 of the first portion 71 of the first extension 16a.

For example, the first surface 10b1 of the bobbin 110 may be the lower surface of the bobbin 110, and the second surface 10b2 of the bobbin 110 may be the bottom surface of the second escape groove in the bobbin 110, without being limited thereto. In another embodiment, the second surface of the bobbin 110 may be formed separately from the second escape groove 112b.

For example, the bobbin 110 may have the first surface 10b1 and the groove depressed from the first surface 10b1. Here, the bottom surface of the groove may be the second surface of the bobbin 110.

The bobbin 110 may further include a surface 13a, which is disposed between the first surface 10b1 and the second surface 10b2 so as to connect the first surface 10b1 to the second surface 10b2. Here, although the surface 13a may be a surface that is perpendicular to the first surface 10b1 or the second surface 10b2, the disclosure is not limited thereto. In another embodiment, the angle defined between the second surface 10b2 of the bobbin 110 and the surface 13a of the bobbin 110 may be an obtuse angle or an acute angle.

The second surface 10b2 of the bobbin 110 may be positioned higher than the first surface 10b1 of the bobbin 110. The second surface 10b2 of the bobbin 110 may be positioned closer to the upper surface 10a of the bobbin 110 than is the first surface 10b1.

The distance between the upper surface 10a of the bobbin 110 and the second surface 10b2 of the bobbin 110 in the optical-axis direction may be less than the distance between the upper surface 10a of the bobbin 110 and the first surface 10b1 of the bobbin 110 in the optical-axis direction.

The description of the surface 13a of the bobbin 110 may also be applied to the surface of the bobbin 110 that is positioned between the third surface 10b3 and the fourth surface 10b4 of the bobbin 110 so as to connect the third surface 10b3 to the fourth surface 10b4.

The lower elastic units 160-1 and 160-2 may respectively include the extensions 16a and 16b, which extend in a direction toward the second surface 10b2 from the first surface 10b1 of the bobbin 110.

For example, the first extension 16a of the first lower elastic unit 160-1 may be disposed at the second frame 31b of the second inner frame 161-1 coupled to the second coupler 117 of the bobbin 110, and may be disposed adjacent to the bore in the bobbin 110.

For example, the second extension 16a of the second lower elastic unit 160-2 may be disposed at the second frame 32b of the second inner frame 161-2, coupled to the second coupler 117 of the bobbin 110, and may be disposed adjacent to the bore in the bobbin 110.

The bobbin may include the projection 51a, which surrounds the bore in the bobbin 110 and projects from the second surface 10b2 of the bobbin 110.

Each of the first and second extensions 16a and 16b may be positioned adjacent to the projection 51a of the bobbin 110. The reason for this is to allow soldering between the first and second extensions 16a and 16c and the two ends 20a and 20b of the coil 120 to be easily performed.

For example, although each of the first and second extensions 16a and 16b may be in contact with the projection 51a, the disclosure is not limited thereto. For example, each of the first and second extensions 16a and 16b may be disposed closer to the projection 51a than to the outer surface of the bobbin 110 (or the edge of the lower surface of the bobbin 110).

The projection 51a of the bobbin 110 may have therein a first opening 58a (see FIG. 5), which is positioned adjacent to the first extension 16a, and a second opening 58b (see FIG. 5), which is positioned adjacent to the second extension 16b. By means of a soldering tool (or a soldering iron) introduced or inserted into the opening 58a, 58b, the coil 120 may be coupled or bonded to the extension 16a, 16b.

Furthermore, the projection 51a of the bobbin 110 may further have openings corresponding to the first groove 180a and the second groove for mounting the sensing magnet 180 and the balancing magnet 185. The reason for this is to allow adhesive to be easily injected into the first and second grooves in the bobbin 110.

The bobbin 110 may include the first projection 54a and a second projection 54b, which are spaced apart from each other, and a third projection 55a and a fourth projection 55b, which are spaced apart from each other. The second surface 10b2 of the bobbin 110 may be positioned or disposed between the first projection 54a and the second projection 54b, and the fourth surface 10b4 of the bobbin 110 may be positioned or disposed between the third projection 55a and the fourth projection 55b.

For example, the first projection 54a and the second projection 54b may project with respect to the second surface 10b2 of the bobbin 110 in the optical-axis direction (for example, in a direction toward the lower surface 10b from the upper surface 10a of the bobbin 110). For example, each of the first and second projections 54a and 54b may project from the second surface 10b2 of the bobbin 110.

The one end 20a of the coil 120 may be disposed or positioned between the first projection 54a and the second projection 54b. By virtue of the first projection 54a and the second projection 54b, the one end 20a of the coil 120 may be stably seated or held on the lower surface of the bobbin 110, whereby it is possible to inhibit the one end 20a of the coil 120 from being moved or separated from the lower surface of the bobbin 110 during soldering, and it is thus possible to improve solderability.

The third projection 55a and the fourth projection 55b may project with respect to the fourth surface 10b4 of the bobbin 110 in the optical-axis direction (for example, in a direction toward the lower surface 10b from the upper surface 10a of the bobbin 110). For example, each of the third and fourth projections 55a and 55b may project from the second surface 10b4 of the bobbin 110.

The other end 20b of the coil 120 may be disposed or positioned between the third projection 55a and the fourth projection 55b. By virtue of the third projection 55a and the fourth projection 55b, the other end 20b of the coil 120 may be stably seated or held on the lower surface of the bobbin 110, whereby it is possible to inhibit the other end 20b of the coil 120 from being moved or separated from the lower surface of the bobbin 110 during soldering, and it is thus possible to improve solderability.

For example, the first projection 54a may be positioned at the first corner portion 110c-1 of the bobbin 110, and the second projection 54b may be positioned at the third side portion 110b-3 of the bobbin 110, without being limited thereto. The third projection 55a may be positioned at the third corner portion 110c-3 of the bobbin 110, and the fourth projection 55b may be positioned at the fourth side portion 110b-4 of the bobbin 110, without being limited thereto.

The second coupler 117 of the bobbin 110 may be disposed at each of the first and third projections 54a and 55a. For example, the first and third projections 54a and 55a may abut on the outer surface of the bobbin 110 (or the edge of the lower surface of the bobbin), and the second and fourth projections 54b and 55b may be spaced apart from the outer surface of the bobbin 110 (or the edge of the lower surface of the bobbin), without being limited thereto. In another embodiment, the first and second projections 54a and 55a may be spaced apart from the outer surface of the bobbin 110 (or the edge of the lower surface of the bobbin), and the second and fourth projections 54b and 55b may abut on the outer surface of the bobbin 110 (or the edge of the lower surface of the bobbin).

The area of the lower surface of each of the first and third projections 54a and 55a may be different from the area of the lower surface of each of the second and fourth projections 54b and 55b. For example, the area of the lower surface of each of the second and fourth projections 54b and 55b may be smaller than the area of the lower surface of each of the first and third projections 54a and 55a.

For example, the lower surface of each of the first and third projections 54a and 55a may be flush with the first surface 10b1 of the bobbin 110, and the lower surface of each of the second and fourth projections 54b and 55b may be flush with the first surface 10b1 of the bobbin 110, or may be higher than the first surface 10b1 of the bobbin 110.

The one end 20a of the coil 120 may include a first portion 20a1, positioned between the first projection 54a and the second projection 54b, and a second portion 20a1, which is connected to the first portion 20a1 and extends to the first extension 16a from the first portion 20a1. The second portion 20a2 may be bent from the first portion 20a1. For example, the second portion 20a2 of the one end 20a of the coil 120 may be coupled to the first extension 16a via soldering.

The other end 20b of the coil 120 may include a third portion 20b1 positioned between the third projection 55a and the fourth projection 55b and a fourth portion 20b2, which is connected to the third portion 20b1 and extends to the second extension 16b from the third portion 20b1. The fourth portion 20b2 may be bent from the third portion 20b1. For example, the fourth portion 20b2 of the other end 20b of the coil 120 may be coupled to the second extension 16b via soldering.

As illustrated in FIG. 16, the second frame connector 163-1 of the first lower elastic unit 160-1 may overlap the second surface 10b2 of the bobbin 110 in the optical-axis direction, and the second frame connector 163-2 of the second lower elastic unit 160-2 may overlap the fourth surface 10b4 of the bobbin 110 in the optical-axis direction.

The second surface 10b2 (and/or the fourth surface 10b4) of the bobbin 110 may include a first area and a second area.

The first area of the second surface 10b2 (and/or the fourth surface 10b4) of the bobbin 110 may be the area in which the second surface 10b2 (and/or the fourth surface 10b4) overlaps the second frame connector 163-1, 163-2 of the first and second lower elastic units 160-1, 160-2 in the optical-axis direction.

The second area of the second surface 10b2 (and/or the fourth surface 10b4) of the bobbin 110 may be the area in which the second surface 10b2 (and/or the fourth surface 10b4) does not overlap the second frame connector 163-1, 163-2 of the first and second lower elastic units 160-1, 160-2 in the optical-axis direction.

The one end 20a and the other end 20b of the coil 120 may be disposed in the second area of the second surface 10b2 of the bobbin 110, and the first extension 16a and the second extension 16b may be disposed in the second area of the second surface 10b2 of the bobbin 110.

The first solder 19a, 19b (see FIGS. 19A to 19C), which couples the one end 20a of the coil 120 to the first extension 16a, and the second solder, which couples the other end 20b of the coil 120 to the second extension 16b, may be disposed in the second area of the second surface 10b2 of the bobbin 110.

Specifically, the one end 20a of the coil 120 and the first extension 16a may be coupled to each other in the second area of the bobbin 110, and the other end 20b of the coil 120 and the second extension 16b may be coupled to each other in the second area of the bobbin 110.

The reason for this is to avoid spatial interference between the second frame connectors 163-1 and 163-2 of the first and second lower elastic units 160-1 and 160-2 and the coil 120, spatial interference between the second frame connectors 163-1 and 163-2 of the first and second lower elastic units 160-1 and 160-2 and the first and second extensions 16a and 16b, and/or spatial interference between the second frame connectors 163-1 and 163-2 of the first and second lower elastic units 160-1 and 160-2 and the first and second solders 19a and 19b.

Referring to FIG. 18, the first extension 16a may include the first portion 71, which extends from the first body of the first lower elastic unit 160-1 and is bent toward the second surface of the bobbin 110.

For example, the first extension 16a may include the first portion 71 and the second portion 72 connected to the first portion 71.

The first portion 71 of the first extension 16a may be connected to the second inner frame 161-1 (for example, the second frame 31b) of the first lower elastic unit 160-1 and may be bent from the second inner frame 161-1. For example, the first portion 71 of the first extension 16a may be bent so as to extend toward the second surface 10b2 from the first surface 10b1 of the bobbin 110.

The second extension 16b may include the third portion connected to the second inner frame 161-2 (for example, the second frame 32b) of the second lower elastic unit 160-2 and a fourth portion connected to the third portion. Here, the description of the first extension 16a shown in FIG. 18 may also be applied to the second extension 16b.

The first portion 71 of the first extension 16a may be disposed on the surface 13a of the bobbin 110, and the second portion 72 may be disposed on the second surface 10b2 (for example, the second area of the second surface 10b2) of the bobbin 110.

For example, although a portion (or one surface) of the first portion 71 of the first extension 16a may be in contact with the surface 13a of the bobbin 110, the disclosure is not limited thereto. In another embodiment, a portion (or one surface) of the first portion 71 of the first extension 16a may be spaced apart from the surface 13a of the bobbin 110.

For example, a portion (or one surface) of the second portion 72 of the first extension 16a may be in contact with the second surface 10b2 of the bobbin 110.

Although the angle Q1 defined between the first portion 71 of the first extension 16a and the second inner frame 161-1 of the first lower elastic unit 160-1 may be equal or almost equal to the angle defined between the first surface 10b1 and the surface 13a of the bobbin 110, the disclosure is not limited thereto. Here, Q1 may be an angle smaller than 180 degrees.

The angle Q2 defined between the first portion 71 and the second portion 72 of the first extension 16a may be equal or almost equal to the angle defined between the second surface 10b2 and the surface 13a of the bobbin 110. Here, Q2 may be an angle smaller than 180 degrees.

For example, each of Q1 and Q2 may be 60-120 degrees. For example, each of Q1 and Q2 may be 85-95 degrees. For example, each of Q1 and Q2 may be 90 degrees.

The length M1 of the first portion 71 of the first extension 16a may be 0.3 mm-0.5 mm.

The length M2 of the second portion 72 of the first extension 16a may be greater than the length M1 of the first portion 71 of the first extension 16a (M2>M1).

For example, the ratio of the length M1 of the first portion 71 to the length M2 of the second portion 72 (M1:M2) may be 1:1.5-1:5. For example, M1:M2=1:1.5−1:3.

If M2/M1 is less than 1.5, because the length M2 of the second portion 72 is short, solderability to the one end of the coil 120 may be deteriorated. If M2/M1 is greater than 5, because the length M1 of the first portion 71 may be excessively shortened and the length M1 of the first portion 71 may be less than the height h1, h2 of the solder 19a, 19b for connecting the coil 120 to the extension 16a, 16b, the length of the lens moving apparatus in the optical-axis direction may be increased.

Here, M1 may be the length of the first portion 71 between the second inner frame 161-1 and the point at which the first portion 71 and the second portion 72 meet each other, and M2 may be the length of the second portion 72 between the point, at which the first portion 71 and the second portion 72 meet each other and the one end of the second portion 72.

Each of the lengths in the cross direction and in the longitudinal direction of the one surface (for example, the lower surface) of the second portion 72 of the first extension 16a, which is coupled to the one end 20a of the coil 120, may be 0.25 mm-1 mm. If each of the lengths in the cross direction and in the longitudinal direction of the one surface (for example, the lower surface) of the second portion 72 of the first extension 16a is less than 0.25 mm, the space required for soldering is insufficient, thereby deteriorating solderability. Meanwhile, if the each of the lengths in the cross direction and in the longitudinal direction of the one surface (for example, the lower surface) of the second portion 72 of the first extension 16a is greater than 1 mm, design freedom of the bobbin 110 may be restricted or the size of the lens moving apparatus may be increased due to spatial interference with the bobbin 110.

For example, each of the lengths in the cross direction and in the longitudinal direction of the one surface (for example, the lower surface) of the second portion 72 of the first extension 16a may be 0.3 mm-0.4 mm.

The solder may be coupled to at least one of the first portion 71 (or the first area) and the second portion 72 (or the second area).

FIG. 19A is a view illustrating an embodiment 19a of the first solder coupling the first extension 16a to the one end 20a of the coil 120.

Referring to FIG. 19A, the lens moving apparatus 100 according to the embodiment may further include the first solder 19a coupling the one end 20a (for example, the second portion 20a2) of the coil 120 to the first extension 16a.

For example, the first solder 19a may be disposed both at the one end 20a (for example, the second portion 20a2) of the coil 120 and at the second portion 72 of the first extension 16a. Although the first solder 19a may be spaced apart from the first portion 71 of the first extension 16a, the disclosure is not limited thereto.

The description of FIG. 19A may be applied to the second solder connecting the second extension 16b to the other end 20b of the coil 120.

FIG. 19B is a view illustrating another embodiment 19b of the first solder coupling the first extension 16a to the one end 20a of the coil 120.

Referring to FIG. 19B, the first solder 19b may be disposed at the one end 20a (for example, the second portion 20a2) of the coil 120 and at the first portion 71 and the second portion 72 of the first extension 16a.

In FIG. 19B, since the first solder 19b is also disposed at the first portion 71 of the first extension 16a, the contact surface between the first solder 19b and the first extension 16a may be increased, thereby improving adhesive force or solderability between the first solder 19b and the first extension 16a.

The description of FIG. 19B may be applied to the second solder coupling the second extension 16b to the other end 20b of the coil 120.

FIG. 19C is a view illustrating a further embodiment 19b of the first solder coupling the first extension 16a to the one end 20a of the coil 120.

Although the one end 20a of the coil 120 is spaced apart from the first portion 71 of the first extension 16a in FIGS. 19A and 19B, the one end of the coil 120 in FIG. 19C may be in contact with the first portion 71 of the first extension 16a, and the contact surface between the coil 120 and the first extension 16a may be increased, thereby increasing the coupling force therebetween.

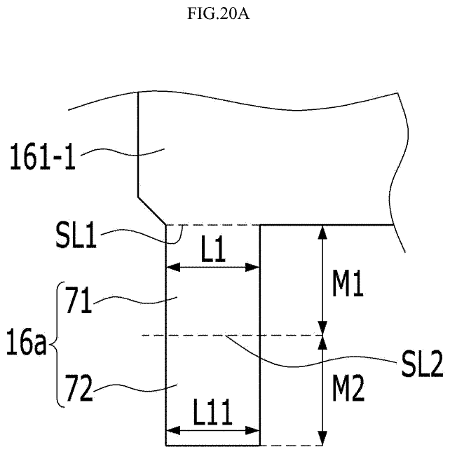

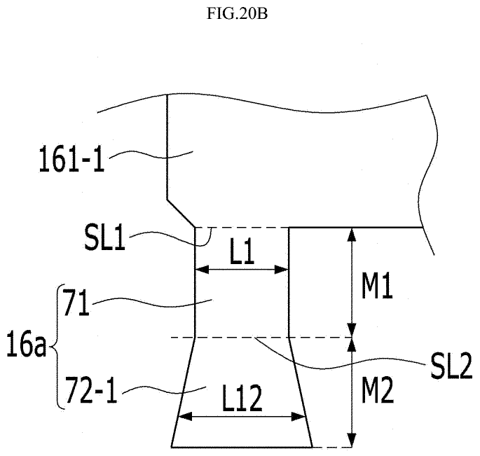

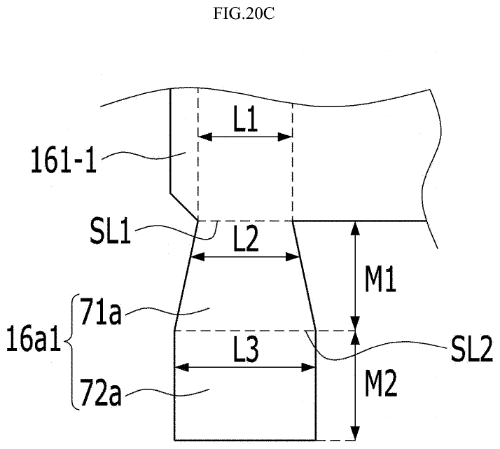

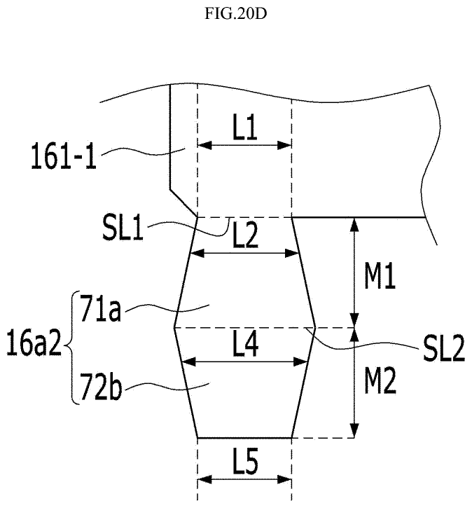

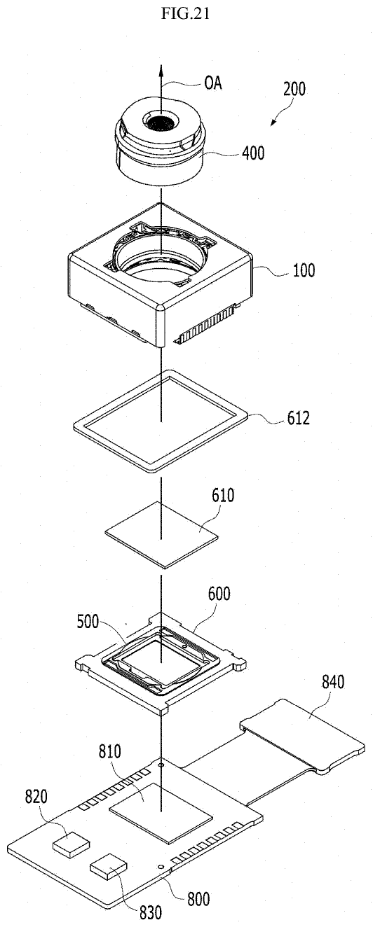

FIG. 20A is a view illustrating the first extension 16a according to an embodiment. FIG. 20A illustrates the shapes of the first portion 71 and the second portion 72 of the first extension 16a before the first portion 71 and the second portion 72 are bent at the boundary lines SL1 and SL2.

Referring to FIG. 20A, the width L1 of the first portion 71 of the first extension 16a may be equal to the width L11 of the second portion 72 of the first extension 16a (L1=L11). Each of the width L1 of the first portion 71 and the width L11 of the second portion 72 may have a constant value. The description of the first extension 16a shown in FIG. 20A may also be applied to the second extension 16b.

FIG. 20B is a view illustrating a first extension 16a1 according to another embodiment.

Referring to FIG. 20B, the width L12 of the second portion 72-1 of the first extension 16a1 may increase moving toward the second portion 72-1 from the second boundary line SL2, at which the first portion 71a and the second portion 72-1 meet each other. Consequently, since the width L12 of the second portion 72-2 is increased, the coupling force between the first extension 16a and the first solder (for example, 19a to 19c) may be increased.

FIG. 20C is a view illustrating a first extension 16a1 according to a further embodiment.

Referring to FIG. 20C, the first extension 16a1 may include a first portion 71a and a second portion 72a.

The width L2 of the first portion 71a of the first extension 16a1 may increase moving toward the second boundary line SL2 at which the first portion 71a and the second portion 72a meet each other from the first boundary line SL1 at which the first portion 71a and the second inner frame 161-1 meet each other.

The width L3 of the second portion 72a of the first extension 16a may be equal to the width of the second boundary line SL2, and may have a constant value. The description of FIG. 20B may also be applied to the second extensions of other embodiments.

FIG. 20D is a view illustrating a first extension 16a2 according to yet a further embodiment.

Referring to FIG. 20D, the first extension 16a2 may include a first portion 71a and a second portion 72b.

The width L4 of the second portion 72b of the first extension 16a2 may decrease moving toward the distal end of the second portion 72b from the second boundary line SL2. For example, the width L5 of the distal end of the second portion 72b of the first extension 16a2 may be less than the width of the second boundary line SL2.

The description of the first extension 16a1 shown in FIG. 20C may also be applied to the second extensions according to other embodiments.

The width L1, L2 may be the length of the first portion 71, 71a in a direction perpendicular to the direction of extension of the first portion 71, 71a, and the width L11, L3, L4 may be the length of the second portion 72 in a direction perpendicular to the direction of extension of the second portion 72, 72a, 72b.

In another embodiment, the width of the first portion of the first extension may decrease moving toward the second boundary line SL2 from the first boundary line SL1.

In a further embodiment, the width of the second portion of the first extension may increase moving toward the distal end of the second portion from the second boundary line SL2.

In yet a further embodiment, the first extension may include a first region, which is disposed between the first portion and the second inner frame and has a width less than the width of the first portion. Here, the first region of the first extension may be the bent portion, and the first portion may be easily bent by virtue of the first region.

In a still further embodiment, the first extension may include a second region, which is disposed between the first portion and the second portion and has a width less than the width of the first portion. Here, the second region of the first extension may be the bent portion, and the second portion may be easily bent by virtue of the second region.

The first and second lower elastic units 160-1 and 160-2 may also be described as follows. For example, the first lower elastic unit 160-1 (or the second lower elastic unit 160-2) may include the first portion (for example, the second inner frame 161-1) coupled to the first surface 10b1 of the bobbin 110, and the second portion (for example, the first portion 71 of the first extension 16a), which is connected to the first portion 161-1 and is bent from the first portion 161-1.

For example, the first lower elastic unit 160-1 (or the second lower elastic unit 160-2) may further include the third portion (for example, the second portion 72 of the first extension 16a), which is connected to the second portion 71, is bent from the second portion 71 and is disposed on the second surface 10b2 of the bobbin 110.

With the miniaturization of terminals or in order to meet the demands of customers, a lens moving apparatus having a reduced height, for example, a VCN is required. In order to meet the demand of customers and to ensure desired electromagnetic force in the limited or restricted space of the lens moving apparatus, the sizes of a coil and a magnet must be increased. In other words, there may be a trade-off relationship between the height of the lens moving apparatus and the sizes of the coil and the magnet of the lens moving apparatus, all of which are requested by customers.

Generally, in order to avoid spatial interference between a lower elastic member and the upper surface of a base, there is a need for a predetermined distance between the lower elastic member and the upper surface of the base. Here, the predetermined distance may be the sum (for example, 0.45 mm) of a downward stroke (for example, 0.15 mm) of a bobbin due to AF operation and a height (for example, 0.3 mm) of solder for coupling the lower elastic member to the coil.

In order to reduce the height of the lens moving apparatus 100, the embodiment employs the space (for example, 112b) in the bobbin 110 such that the bobbin 110 is moved downwards during AF operation without spatial interference with the lower elastic member 160.

Specifically, portions of the second inner frames 161-1 and 161-2 of the lower elastic unit 160-1 and 60-2 are bent into the second escape groove 112b in the bobbin 110 so as to form the extensions 16a and 16b, which serve as soldering pads for bonding to the coil 120, and the formed extensions 16a and 16b are coupled to the two ends of the coil through soldering. Consequently, according to the embodiment, soldering can be performed at a position higher than the first surface 10b1 of the bobbin to which the lower elastic units 160-1 and 160-2 are coupled, and solders 19a and 19b are formed at a level higher than the first surface 10b1 of the lower surface 10b of the bobbin 110, thereby offering an effect of reducing the height of the lens moving apparatus 100 by about 0.3 mm.

Although FIGS. 1 to 20C illustrate the structure in which the coil 120 is connected to the first and second lower elastic units 160-1 and 160-2, the disclosure is not limited thereto. In another embodiment, the upper elastic member may include first and second upper elastic units, and the coil 120 may be connected to the first and second upper elastic units.

The description of the first and second lower elastic units 160-1 and 160-2, which are given with reference to FIGS. 1 to 20C, may be applied to the first and second upper elastic units according to another embodiment without change or with modification.

For example, the first upper elastic unit according to the another embodiment may include components corresponding to the components of the first lower elastic unit 160-1, and the second upper elastic unit may include components corresponding to the components of the first lower elastic unit 160-1.

In another embodiment, a first extension corresponding to the first extension 16a of the first lower elastic unit 160-1 may be provided to the first inner frame of the first upper elastic unit, and a second extension corresponding to the second extension 16b of the second lower elastic unit 160-2 may be provided to the first inner frame of the second upper elastic unit.

However, the direction of each of the first and second extensions according to the another embodiment may be opposite the direction of each of the first and second extensions 16a and 16b, and the positions of the first and second surfaces of the bobbin 110 may be reversed. In other words, in the another embodiment, the first surface of the bobbin 110 may be positioned higher than the second surface.

For example, the shapes of the first and second extensions according to the another embodiment may be the same as those of the first and second extensions 16a and 16b, which are rotated by 180 degrees. Furthermore, in place of the second escape groove 112b in the bobbin 110, the first escape groove 112a in the bobbin 110 may be applied to the another embodiment.

Meanwhile, the lens moving apparatuses according to the above-described embodiments may be used in various fields, such as, for example, a camera module or an optical device.

For example, the lens moving apparatus 100 according to the embodiment may be included in an optical instrument, which is designed to form an image of an object in a space using reflection, refraction, absorption, interference, diffraction or the like, which are characteristics of light, to extend eyesight, to record an image obtained through a lens or reproduce the image, to perform optical measurement, or to propagate or transmit an image. For example, the optical instrument according to the embodiment may be a smart phone or a portable terminal equipped with a camera.

FIG. 21 is an exploded perspective view illustrating a camera module 200 according to an embodiment.

Referring to FIG. 21, the camera module 200 may include a lens or a lens module 400, the lens moving apparatus 100, an adhesive member 612, a filter 610, a first holder 600, a second holder 800, an image sensor 810, a motion sensor 820, a controller 830 and a connector 840.

The lens or the lens barrel 400 may be mounted in the bobbin 110 of the lens moving apparatus 100.

The first holder 600 may be disposed under the base 210 of the lens moving apparatus 100. The filter 610 may be mounted on the first holder 600, and the first holder 600 may include a projection 500 on which the filter 610 is seated.

The adhesive member 612 may couple or attach the base 210 of the lens moving apparatus 100 to the first holder 600. In addition to the attachment function described above, the adhesive member 612 may serve to inhibit contaminants from entering the lens moving apparatus 100.

For example, the adhesive member 612 may be, for example, epoxy, thermohardening adhesive, or ultraviolet hardening adhesive.

The filter 610 may serve to inhibit light within a specific frequency band that passes through the lens barrel 400 from being introduced into the image sensor 810. The filter 610 may be, for example, an infrared-light-blocking filter, without being limited thereto. Here, the filter 610 may be oriented parallel to the X-Y plane.

The region of the first holder 600 in which the filter 610 is mounted may be provided with a bore in order to allow the light that passes through the filter 610 to be introduced into the image sensor 810.

The second holder 800 may be disposed under the first holder 600, and the image sensor 810 may be mounted on the second holder 600. The image sensor 810 may be the region, on which an image included in the light that passes through the filter 610 and is introduced thereinto is formed.

The second holder 800 may include, for example, various circuits, devices, and a controller in order to convert the image, formed on the image sensor 810, into electrical signals and to transmit the electrical signals to an external component.

The second holder 800 may be embodied as a circuit board on which the image sensor 810 may be mounted, on which a circuit pattern may be formed, and to which various devices may be coupled.

The image sensor 810 may receive an image included in light, which is introduced through the lens moving apparatus 100, and may convert the received image into an electric signal.

The filter 610 and the image sensor 810 may be spaced apart from each other so as to be opposite each other in the first direction.

The motion sensor 820 may be mounted on the second holder 800, and may be conductively connected to the controller 830 through the circuit pattern formed on the second holder 800.

The motion sensor 820 may output rotational angular speed caused by motion. The motion sensor 820 may be embodied as a dual-axis or triple-axis gyro sensor or an angular speed sensor.

The controller 830 may be mounted on the second holder 800. The second holder 800 may be conductively connected to the lens moving apparatus 100. For example, the second holder 800 may be conductively connected to the circuit board 190 of the lens moving apparatus 100.

For example, a drive signal may be supplied to the position sensor 170 through the second holder 800, and the signal output from the position sensor 170 may be transmitted to the second holder 800. For example, the signal output from the position sensor 170 may be received by the controller 830.

The connector 840 may be conductively connected to the second holder 800, and may have therein a port that is intended to be conductively connected to an external device.

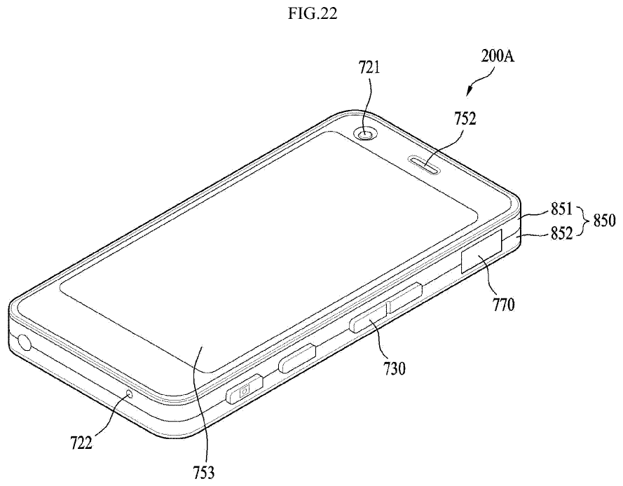

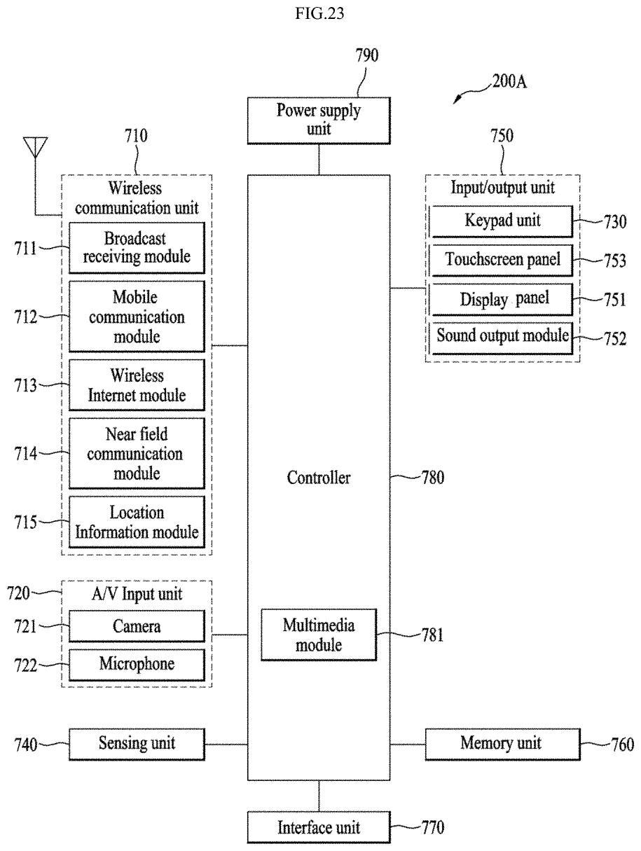

FIG. 22 is a perspective view illustrating a portable terminal 200A according to an embodiment. FIG. 23 is a view illustrating the configuration of the portable terminal 200A shown in FIG. 22.

Referring to FIGS. 22 and 23, the portable terminal 200A (hereinafter referred to as a “terminal”) may include a body 850, a wireless communication unit 710, an audio/video (A/V) input unit 720, a sensing unit 740, an input/output unit 750, a memory unit 760, an interface unit 770, a controller 780, and a power supply unit 790.

The body 850 shown in FIG. 22 has a bar shape, without being limited thereto, and may be any of various types, such as, for example, a slide type, a folder type, a swing type, or a swivel type, in which two or more sub-bodies are coupled so as to be movable relative to each other.

The body 850 may include a case (e.g. a casing, housing, or cover) defining the external appearance of the terminal. For example, the body 850 may be divided into a front case 851 and a rear case 852. Various electronic components of the terminal may be accommodated in the space defined between the front case 851 and the rear case 852.

The wireless communication unit 710 may include one or more modules, which enable wireless communication between the terminal 200A and a wireless communication system or between the terminal 200A and a network in which the terminal 200A is located. For example, the wireless communication unit 710 may include a broadcast reception module 711, a mobile communication module 712, a wireless Internet module 713, a nearfield communication module 714, and a location information module 715.

The A/V input unit 720 serves to input audio signals or video signals, and may include, for example, a camera 721 and a microphone 722.

The camera 721 may include the camera module 200 according to the embodiment shown in FIG. 21.

The sensing unit 740 may sense the current state of the terminal 200A, such as, for example, opening or closing of the terminal 200A, the location of the terminal 200A, the presence of a user's touch, the orientation of the terminal 200A, or the acceleration/deceleration of the terminal 200A, and may generate a sensing signal to control the operation of the terminal 200A. When the terminal 200A is, for example, a slide-type cellular phone, the sensing unit 740 may sense whether the slide-type cellular phone is opened or closed. Furthermore, the sensing unit 740 may sense the supply of power from the power supply unit 790, coupling of the interface unit 770 to an external device, and the like.

The input/output unit 750 serves to generate, for example, visual, audible, or tactile input or output. The input/output unit 750 may generate input data to control the operation of the terminal 200A, and may display information processed in the terminal 200A.

The input/output unit 750 may include a keypad unit 730, a display module 751, a sound output module 752, and a touchscreen panel 753. The keypad unit 730 may generate input data in response to input on a keypad.

The display module 751 may include a plurality of pixels, the color of which varies depending on the electrical signals applied thereto. For example, the display module 751 may include at least one among a liquid crystal display, a thin-film transistor liquid crystal display, an organic light-emitting diode, a flexible display and a 3D display.

The sound output module 752 may output audio data received from the wireless communication unit 710 in, for example, a call-signal reception mode, a call mode, a recording mode, a voice recognition mode, or a broadcast reception mode, or may output audio data stored in the memory unit 760.

The touchscreen panel 753 may convert variation in capacitance, caused by a user's touch on a specific region of a touchscreen, into electrical input signals.

The memory unit 760 may temporarily store programs for processing and control of the controller 780 and input/output data (for example, telephone numbers, messages, audio data, stationary images, moving images and the like). For example, the memory unit 760 may store images captured by the camera 721, for example, pictures or moving images.

The interface unit 770 serves as a path through which the lens moving apparatus is connected to an external device connected to the terminal 200A. The interface unit 770 may receive power or data from the external component, and may transmit the same to respective constituent elements inside the terminal 200A, or may transmit data inside the terminal 200A to the external component. For example, the interface unit 770 may include a wired/wireless headset port, an external charger port, a wired/wireless data port, a memory card port, a port for connection to a device equipped with an identification module, an audio input/output (I/O) port, a video input/output (I/O) port, an earphone port and the like.

The controller 780 may control the overall operation of the terminal 200A. For example, the controller 780 may perform control and processing related to, for example, voice calls, data communication, and video calls.

The controller 780 may include a multimedia module 781 for multimedia playback. The multimedia module 781 may be embodied in the controller 180, or may be embodied separately from the controller 780.

The controller 780 may perform a pattern recognition process capable of recognizing writing input or drawing input carried out on a touch screen as a character and an image, respectively.

The power supply unit 790 may supply power required to operate the respective constituent elements upon receiving external power or internal power under the control of the controller 780.

The features, configurations, effects and the like described above in the embodiments are included in at least one embodiment, but the invention is not limited only to the embodiments. In addition, the features, configurations, effects and the like exemplified in the respective embodiments may be combined with other embodiments or modified by those skilled in the art. Accordingly, content related to such combinations and modifications should be construed as falling within the scope of the disclosure.

### INDUSTRIAL APPLICABILITY

The embodiments are applicable to a lens moving apparatus, which is capable of reducing the size thereof in the optical-axis direction and improving solderability between a coil and an elastic unit, and a camera module and an optical device each including the same.

1. A lens moving apparatus comprising:
a housing;
a bobbin disposed in the housing;
a coil disposed at the bobbin;
a magnet disposed at the housing; and
an elastic member coupled to the bobbin,
wherein the elastic member comprises a body and an extension, which extends from the body,
wherein the bobbin comprises a first surface and a second surface having a height difference from the first surface,
wherein the body is disposed on the first surface of the bobbin, and
wherein the extension comprises a first region, which is coupled to the coil and is bent toward the second surface of the bobbin from the body.

2. The lens moving apparatus according to claim 1, wherein the elastic member is disposed under the bobbin.

3. The lens moving apparatus according to claim 1, wherein the coil is soldered to the extension so as to be conductively connected to the extension.

4. The lens moving apparatus according to claim 1, wherein the bobbin comprises a third surface and a fourth surface having a height difference from the third surface,
wherein the elastic member comprises a first elastic unit and a second elastic unit,
wherein the first elastic unit comprises a first body and a first extension, which extends from the first body and is bent toward the second surface, and
wherein the second elastic unit comprises a second body and a second extension, which extends from the second body and is bent toward the fourth surface.

5. The lens moving apparatus according to claim 4, wherein the second surface of the bobbin and the fourth surface of the bobbin are the same surface.

6. The lens moving apparatus according to claim 4, wherein the second surface of the bobbin and the fourth surface of the bobbin are disposed in the same plane, and the first surface of the bobbin and the third surface of the bobbin are disposed in the same plane.

7. The lens moving apparatus according to claim 4, wherein the extension comprises a second region, which is bent from the first region and is disposed on the second surface.

8. The lens moving apparatus according to claim 1, wherein the elastic member is disposed under the bobbin,
wherein a lower surface of the bobbin comprises the first surface and the second surface, and
wherein the second surface is positioned higher than the first surface.

9. The lens moving apparatus according to claim 4, wherein the first elastic unit comprises a first inner portion coupled to the bobbin, a first outer portion coupled to the housing, and a first connector connecting the first inner portion to the first outer portion, and
wherein the second elastic unit comprises a second inner portion coupled to the bobbin, a second outer portion coupled to the housing, and a second connector connecting the second inner portion to the second outer portion.

10. The lens moving apparatus according to claim 9, wherein the first connector overlaps the second surface of the bobbin in an optical-axis direction, and
wherein the second connector overlaps the fourth surface of the bobbin in the optical-axis direction.

11. The lens moving apparatus according to claim 4, wherein the bobbin comprises first and second projections, which are spaced apart from each other, and third and fourth projections, which are spaced apart from each other, and
wherein a first end of the coil is disposed between the first and second projections, and a second end of the coil is disposed between the third and fourth projections.

12. The lens moving apparatus according to claim 11, wherein the second surface of the bobbin is disposed between the first projection and the second projection, and the second surface is disposed between the third projection and the fourth projection.

13. The lens moving apparatus according to claim 7, comprising:
a first solder connecting the first end of the coil to the first extension; and
a second solder connecting the second end of the coil to the second extension,
wherein a height of each of the first and second solders is less than the height difference between the first surface and the second surface.

14. The lens moving apparatus according to claim 13, wherein a height of each of the first solder and second solder is equal to or less than a length of the first region in the optical-axis direction.

15. The lens moving apparatus according to claim 13, wherein each of the first and second solders is coupled to one of the first and second regions of the first extension.

16. The lens moving apparatus according to claim 1, comprising:
a sensing magnet disposed on the bobbin; and
a position sensor disposed on the housing and configured to detect a magnetic field of the sensing magnet.

17. The lens moving apparatus according to claim 16, comprising:
a base disposed under the housing; and
a circuit board disposed on the housing and electrically connected to the position sensor.

18. A lens moving apparatus comprising:
a bobbin;
a coil disposed on the bobbin;
a magnet disposed so as to face the coil; and
an elastic member coupled to the bobbin,
wherein the elastic member comprises a first elastic unit and a second elastic unit spaced apart from the first elastic unit,
wherein the first elastic unit comprises a first body and a first extension extending from the first body,
wherein the bobbin comprises a first surface and a second surface formed at a level different from a level of the first surface,
wherein a portion of the first body is disposed on the first surface of the bobbin, and
wherein the first extension is disposed on the second surface of the bobbin and is coupled to the coil.

19. A lens moving apparatus comprising:
a housing;
a bobbin disposed in the housing;
a coil disposed on the bobbin;
a magnet disposed on the housing; and
an elastic member coupled to the bobbin,
wherein the elastic member comprises a first elastic unit and a second elastic unit,
wherein the bobbin comprises a first surface to which the first elastic unit and the second elastic unit are coupled and a second surface having a height difference from the first surface in an optical-axis direction,
wherein the first elastic unit comprises a first inner portion coupled to the first surface of the bobbin and a first extension extending toward the second surface from the first surface of the bobbin,
wherein the second elastic unit comprises a second inner portion coupled to the first surface of the bobbin and a second extension connected to the second inner portion and extending toward the second surface from the first surface of the bobbin, and
wherein a first end of the coil is coupled to the first extension, and a second end of the coil is coupled to the second extension.

20. The lens moving apparatus according to claim 19, wherein the first elastic unit comprises a first outer portion coupled to the housing and a first connector connecting the first inner portion to the first outer portion,
wherein the second elastic unit comprises a second outer portion coupled to the housing and a second connector connecting the second inner portion to the second outer portion,
wherein the second surface of the bobbin comprises a first area which overlaps the first and second connectors in the optical-axis direction, and a second area which does not overlap the first and second connectors in the optical-axis direction,
wherein the first end of the coil and the first extension are coupled to each other in the second area, and wherein the second end of the coil and the second extension are coupled to each other in the second area.
